(19) United States
(12) Patent Application Publication
(10) Pub. No.: US 2011/0209286 A1
(43) Pub. Date: Sep. 1, 2011

(54) LEG SUPPORT FOR ROTATING SLEEP SURFACE TRANSFER SYSTEM

(76) Inventor: McGee Dane, Collingham (GB)

(21) Appl. No.: 13/054,927

(22) PCT Filed: Jul. 21, 2009
(86) PCT No.: PCT/GB09/50896

§ 371 Date: May 13, 2011

(30) Foreign Application Priority Data
Jul. 23, 2008 (GB) 0813466.0
Jul. 23, 2008 (GB) 0813467.8
Jul. 23, 2008 (GB) 0813471.0

(51) Int. Cl. A61G 7/16; A61G 7/10; A61G 5/12

(52) U.S. Cl. 5/619

(57) ABSTRACT

An occupant transfer system comprising a bed including a mattress or other sleep support structure mounted on an endless loop of flexible material, the loop extending over a plurality of rollers or guide members extending longitudinally of the bed; drive means adapted to cause rotation of the endless loop so that the sleep support structure moves laterally across the bed so that an occupant located on the sleep support structure is moved laterally across the bed in use.

This invention relates to a transfer system for transferring an occupant, patient or resident (referred to hereafter for brevity as “an occupant”) from one bed to another or from a bed to a transfer table or vice versa in circumstances in which the occupant is bedridden or unable to move independently between one bed and another or between a bed and transfer table. Lifting a heavy occupant from a bed to a transfer table can be difficult, uncomfortable and undignified, and abrasion between the occupant's body and an underlying sheet when being manually handled or lifted can cause or exacerbate bedsores, particularly if the movement is repeated frequently.

It is an object of the present invention to provide an occupant transfer system which permits an occupant to be moved from one bed or transfer table to another without a need for lifting equipment or manual lifting by nursing assistants.

In the following specification, the bed or transfer table is referred to for brevity as a “bed”. However, it should be appreciated that the term “bed” is used to refer to a transfer table, trolley or other structure upon which an occupant may be laid.

According to the present invention, an occupant transfer system comprises a transfer table including a mattress or other sleep support structure mounted on an endless belt, the belt extending in a loop over a plurality of rotatable drive members extending longitudinally of the table;

drive means adapted to cause rotation of the endless belt so that the sleep support structure moves laterally across the table and so that an occupant located on the sleep support structure is moved laterally across the table in use;

a leg support, a seat support and a back or head support arranged to be moveable from a first orientation wherein the supports form a horizontal surface and a second orientation wherein the supports form a chair in which the seat is generally horizontal; the back or head support extends upwardly and the leg support extends downwardly from the seat;

the leg support being moveable between a deployed position in which it may be moved between the first and second orientations and a stowed position in which the leg support is located beneath the seat so that the leg support may not contact a user's legs in use. The leg support is preferably mounted on a carriage moveable between the deployed position and the stowed position. The carriage may comprise rollers or sliding members mounted on a track extending beneath the seat.

This arrangement is particularly advantageous to relieve pressure sores on an occupant's calves when in the seated position in the chair. A foot rest may be provided to support the soles of an occupant's feet after the leg support has been moved to the stowed position.

Furthermore the depth of the seat may be selected to suit an occupant's size without a need to adjust after the dimensions of the supporting frame.

In a preferred embodiment of the invention, the system may comprise two or more support tables or a support table and bed. These may be adapted for use together so that an occupant may be transferred from one bed or support table to the other. In this arrangement, the endless loops of both bed and table or of both the tables are arranged to be actuated simultaneously so that the individual mattresses or support surfaces form a continuously movable support surface.

A transfer system in accordance with this invention facilitates movement of a disabled, immobile, infirm or otherwise physically or mentally incapacitated occupant from one bed to another in a safe, comfortable and dignified manner without the need for lifting, manual assistance or lifting devices.

Use of the system of this invention allows an occupant to be moved from a sleep surface so that the sheets or other bedding may be changed without causing friction to the occupant's body. Also, the occupant can be transferred onto clean bed sheets without the need for physical lifting or other discomfort.

The drive means may comprise an electric motor or pneumatic actuator. Alternatively or in addition a manual drive may be employed. A manual drive may be useful in the event of a power failure or in remote locations.

In a first embodiment of this invention, the drive mechanism for the table may include two conveyor drive shafts extending longitudinally of each of the leg, scat and back or head support portions of the table, the shafts being connectable in use by detachable couplings between the leg support and seat and between the seat and back or head supports, rotatable members on either side of the seat, head and foot portions being operably connected to a respective main shaft so that rotation of the main shaft causes rotation of the rotatable members and movement of the conveyor. When the table surface is in the horizontal orientation.

In an alternative preferred embodiment, a single drive shaft extends longitudinally of each of the table, axially of the leg, seat and back or head support portions, the shafts being connectable in use by detachable couplings between the leg, seat and back or head portions, each shaft being connected to rotatable members so that rotation of the shafts causes rotation of the rotatable members and movement of the conveyor when the table surface is in the horizontal orientation.

The rotatable members may comprise a drive shaft having one or more rollers or sprockets mounted thereon.

The main drive shafts are preferably connected to the rotatable members by a pulley and belt or sprocket and chain arrangement. Alternatively toothed gears may be used.

Couplings are provided so that each main drive shaft may be connected to a drive unit. The couplings and drive unit are preferably located at the foot portion of the transfer table.

The diameter of the sprockets or rollers limits the minimum thickness of the transfer table conveyor. Larger diameter sprockets or rollers such as are useable on a bed may not be preferred because the thickness of the conveyor must be sufficiently small to be accommodated within the transfer table structure particularly to allow folding into the chair configuration and stowing of the leg support. For this reason direct drive shafts may be preferred.

The drive mechanism for the transfer table include a detachable coupling to allow the drive shaft of the bed or transfer table to be folded upwards or downwards from a horizontal position in which the conveyors may be driven. The couplings are arranged to allow the shafts to be driveably reconnected when returned to the horizontal position.

In a preferred embodiment the coupling comprises male and female portions mounted on respective shafts, at least one of the male and female portions being outwardly biased by spring means, the male and female portions being disengageable when the shafts are separated but being reengageable when the shafts are brought together, the male portion including a projection receivable within a socket in the female portion to engage the shafts while one of the shafts is rotated in either the clockwise or anticlockwise direction.

In a preferred embodiment the male portion comprises an engagement disc mounted transversely on the shaft and having two diametrically opposed projections extending from the disc parallel to the axis of rotation of the shaft; the female portion including an engagement disc mounted transversely on a shaft and having two diametrically opposed sockets dimensioned to receive the projections of the male member.

Preferably the projections comprise cylindrical pins having domed or rounded ends. The pins may be mounted on outwardly biased spring loaded supports.

Preferably the sockets comprise radially extending slots. The slots may be parallel sided or may be V-shaped or otherwise increasing in width away from the axis of rotation.

The female portion may comprise a disc having two diametrically opposed radially extending slots extending wholly or partially through the thickness of the disc.

The preferred coupling arrangement has the advantage of being tolerant of substantial misalignment of the shafts in either the angular or radial directions in use. The arrangement is also robust and can withstand heavy handling in a domestic or hospital environment.

Spring loading of one or both of the members allows the components to be engaged or disengaged without damage or excessive wear to the engagement surfaces.

Alternatively the drive shaft may have articulated linkages between the foot, seat and head portions to allow the head portion conveyor to he driven when in both the horizontal position or in an inclined position. This allows an occupant who is unable to lie on a horizontal surface to be transferred from the bed to a transfer table and vice versa.

The mattress or sleep support structure, hereinafter referred to in this specification for brevity as “the mattress” may be made from open or closed cell foamed material, textile material or artificial or natural fibrous material having sufficient resilience to allow passage around a roller or low friction support or guide surface in use while providing comfortable support for an occupant. A memory foamed material, for example a visco elastic foamed material, is preferred.

The mattress has a multiplicity of V-shaped longitudinal grooves on the underside thereof dimensioned to allow the mattress to be curved around the rollers or guide members without distortion. The apical angle of the longitudinal grooves is preferably within the range of 30-45°. The use of V-shaped grooves also allows the support characteristics of the mattress to be maintained during rotation around the rollers or guide members. The longitudinal V-shaped grooves preferably are of specific dimensions to enable the mattress or pad to be rotated around the drive sprockets without significantly distorting their shape or support characteristics. The thickness of the pad may be 75 mm. Typically, and as an example for a 150 mm thick mattress the depth of the V-shaped groove would be nominally between 60 and 75% of the depth of the mattress. The base width of each V-shaped groove would be nominally 40-60% of the depth of the V-shaped groove. The actual V-shaped groove dimensions and mattress and pad thickness can vary subject to the support characteristics required for the sleep and support surfaces for any given application. Therefore a heavier user may require a thicker mattress or pads made of less flexible foams. In such an instance the V-shaped grooves dimensions may be larger than the nominal ratios stated against mattress and pad thickness to ensure they both can be rotated around the relevant sets of rollers or drive sprockets.

Each mattress section may have one or more, preferably one laterally extending V-shaped groove arranged generally centrally of the mattress to allow the upper part of the mattress to be inclined or declined without stretching the base support foam to an undue extent.

The mattress may have a laminar structure with an upper layer of viscoelastic or polyurethane memory foam supported on one or more layers of conventional foamed materials. A strengthening base layer comprising an inextensible sheet of rubber or polymeric material may be provided. A reinforced composite base layer or intermediate layer may be employed.

The bed or transfer table may incorporate an active pressure relieving system. An active pressure relieving system (APR) is a system whereby the user is supported on a suitable base that can vary its height and firmness either to preset patterns or timings or at random. An APR system therefore is designed to alleviate the applied pressure that the sleep or support surface provides for different areas of the body which come into contact with it. An example is an APR system based upon an inflatable mattress that is made up of several sections. Each section can be inflated independently of the others to support the user using combinations of different sections and as a result to relieve pressure on different areas of the body in contact with it for pre-determined lengths of time. Many types of APR system which use a variety of inflation and adjustment mechanisms are currently available to suit various user requirements. A static pressure relieving system (SPR) is usually a reference to technology such as memory foam and other types of mattresses (such as gel or water mattresses). These alleviate pressure by the nature of their support materials, but do not actively change their shape, firmness or area they support by independently controllable means. A hybrid pressure relieving system that uses a combination of active/dynamic and static pressure relieving technology may be used.

The bed may comprise a single mattress having the length and width of a conventional transfer table.

Alternatively two or more, preferably three or four, more preferably three, simultaneously or independently movable support sections may be arranged longitudinally on respective conveyors to provide a foldable structure so that parts of the bed may be raised or lowered to allow an occupant's head or feet to be raised or lowered and to generally make an occupant more comfortable. This allows the system to be used to transfer disabled occupants who may be fixed in various bodily positions due to palsy, muscle spasms or cramps.

The entire mattress or separate support sections may be enclosed in an inner cover made from a waterproof, vapour permeable base and an elastic material for example cotton based fabric which allows the mattress or section to be flexible in use. The base cover may have a top cover attachable to it, the top cover being made of a waterproof vapour permeable material. The top cover may be attached by means of sliding clasp fasteners or clips to allow removal and replacement. The top cover may have a longer or wider dimension than the inner cover to allow a good fit over the inner cover and mattress in use. The additional length is determined by the diameter that the mattress will form when rotated over the roller or guide member. The length is sufficient to ensure that the top cover when curved around the sprocket or roller is not subject to sufficient torsion to distort the shape and support characteristics of the mattress during rotation.

Preferably each of the seat, head or foot portions includes an endless belt driven by sprockets on each side of the mattress. It is advantageous that both sprockets are driven, so that the belt is maintained under tension and positively driven in either direction.

In a preferred embodiment the belt is a modular belt. A modular belt may comprise modules connected with rigid connecting pins. The length of the modules may determine the pitch of the belt and the width of the modules when combined may determine a desired width of the belt. The underside of a module may have a suitable profile for example teeth to enable them to engage and be driven by complementary formations e.g. sockets in the sprocket. This arrangement provides a positive drive system for the conveyor. This is advantageous in comparison to a traditional conveyor belt which is driven by a combination of tension and friction. The use of a modular belt allows the mattress and cover to be fixed semi-permanently to the modules. A variety of fixing methods may be used, for example using hooks and clips or hook and pile fasteners.

In a preferred embodiment the modular belt serves as a movable platform for the mattress. Furthermore the belt may comprise a combination of open and solid modules. An open module comprises a solid module including holes of specific sizes and pitch, molded or machined into the module to achieve a desired level of perforation. Solid modules are used where the mattress and pad covers are connected to the belt and the open modules are used for the remainder of the belt. The open modules allow air to flow through the belt to assist in keeping the mattress and pads both dry and cool. Solid modules may be preferred for ease of cleaning. Each module may have one or more holes located on opposite ends to receive a connecting pin.

The endless conveyor belt may be assembled by inserting a removable pin of a required length through holes in each row of modules at either end of the belt. This arrangement makes the assembly of the belt easy, allowing it to be fitted to the bed or removed without difficulty for replacement or repair. This avoids a need for expensive dismantling and rebuilding by skilled personnel.

The endless loop may be made of flexible material, preferably of polymeric modular belting, for example composed of acetal, polyethylene, polypropylene or other polyolefin material, polyamide or polybutylene terephthalate. Toothed or plain conveyor belting may be employed, including composite materials composed of polymeric sheets with reinforcing webs. V-belts, toothed belts or plain belts may be employed to facilitate connection to a drive unit.

Sprockets may be moulded or machined from polyacetal or other polymers. The pins to connect the modules may be made from the modular material, polyacetal or a suitable grade of stainless steel.

In preferred embodiments the pitch of the belt is between about 10-50 mm although a larger pitch may be utilised if greater load bearing characteristics are required for a system to be used in bariatric applications for treatment of obese patients

One or more sets of cylindrical rollers or sprockets mounted on drive shafts may be mounted on bearings on either side of each of the head or foot portions of the bed, allowing rotation of the endless belt across the width of the bed. Alternatively or in addition, profiled support or guide members extending longitudinally of the bed may be provided with low friction surfaces, for example coated with polytetrafluoroethylene to allow easy passage of the belt.

The system may be adapted to facilitate washing and/or changing of an occupant. For example, the rollers and drive mechanism of a transfer table may be composed of water resistant, non corrodible materials adapted for easy cleaning after use.

Control means may he provided to allow an operator to actuate the apparatus or to allow an occupant to actuate the apparatus without the need for an operator.

The drive means may comprise a mains or battery powered electrical motor. A manually operated mechanism or a combination of manual and electrically powered actuators may be used.

Engagement means, for example a docking mechanism, may be attached to the transfer table, allowing two or more tables or a bed or transfer table to be securely engaged together during use, so that the system remains stable during the transfer process.

One or both of the bed and transfer table are preferably adapted so that the height from the floor may be adjusted to facilitate easy transfer of the occupant from one to the other or to allow the occupant to be turned onto his or her side during transfer.

The conveyors of the transfer table and the bed may be actuated to rotate simultaneously at the same speed in the same direction. Alternatively or in addition, the loops may be controlled to rotate independently at different speeds and/or in different directions, for example, to facilitate turning an occupant.

The bed or transfer table may each be fitted with castors or wheels to allow easy movement. The bed or table may be fitted with adjustable feet adapted to act as stabilisers during movement. The feet may be arranged to raise the bed or table so that the castors are not in contact with the floor to provide stability during use.

The system of the present invention finds particular use in private or public hospitals, hospices or specialist schools. The system may also find application in private or public care homes, sheltered housing or private residences, particularly in situations in which there may not be sufficient able bodied personnel to allow a patient to be manually assisted into and out of bed.

The invention is further described by means of example, but not in any limitative sense, with reference to the accompanying drawings, of which:—

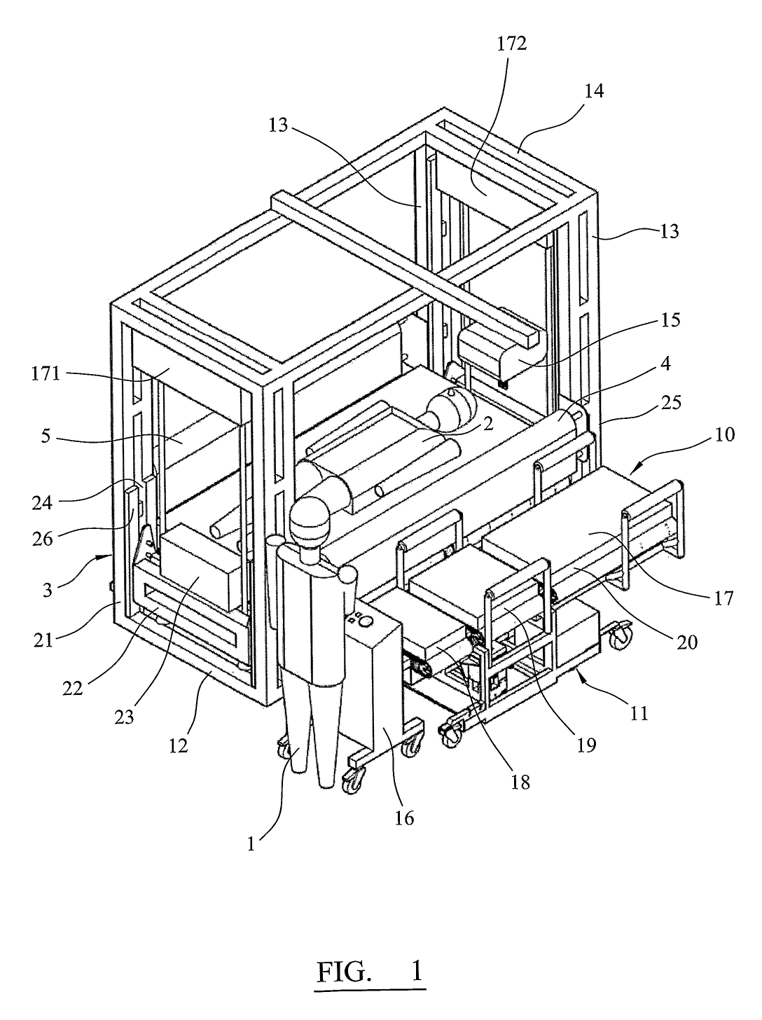

FIG. 1 is a perspective view of a transfer system in accordance with this invention;

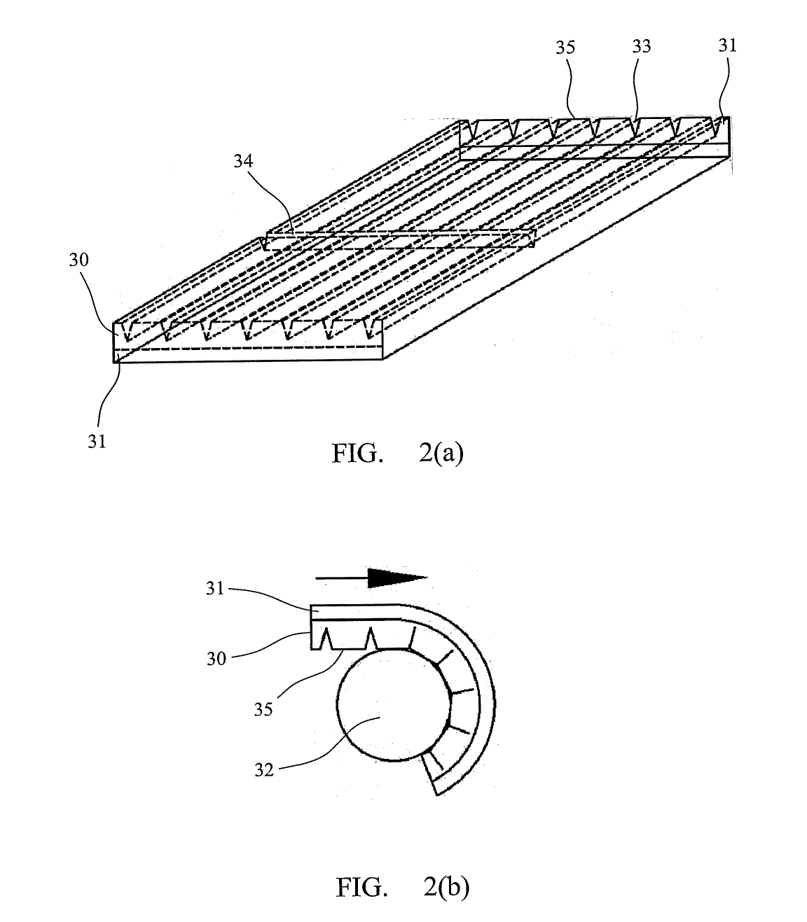

FIGS. 2(a) and 2(b) show a mattress for use in the system of this invention;

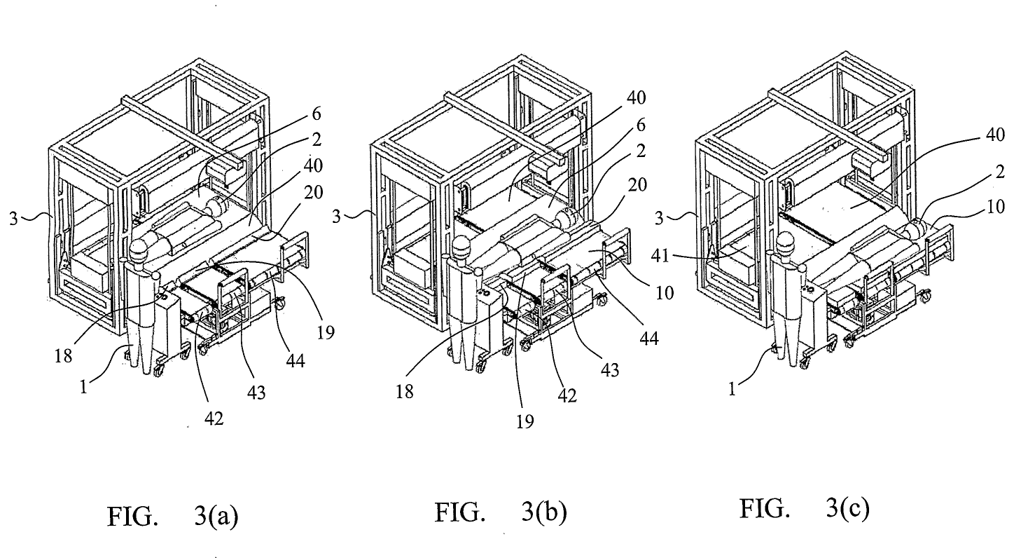

FIGS. 3(a) to 3(c) are perspective views illustrating movement of an occupant;

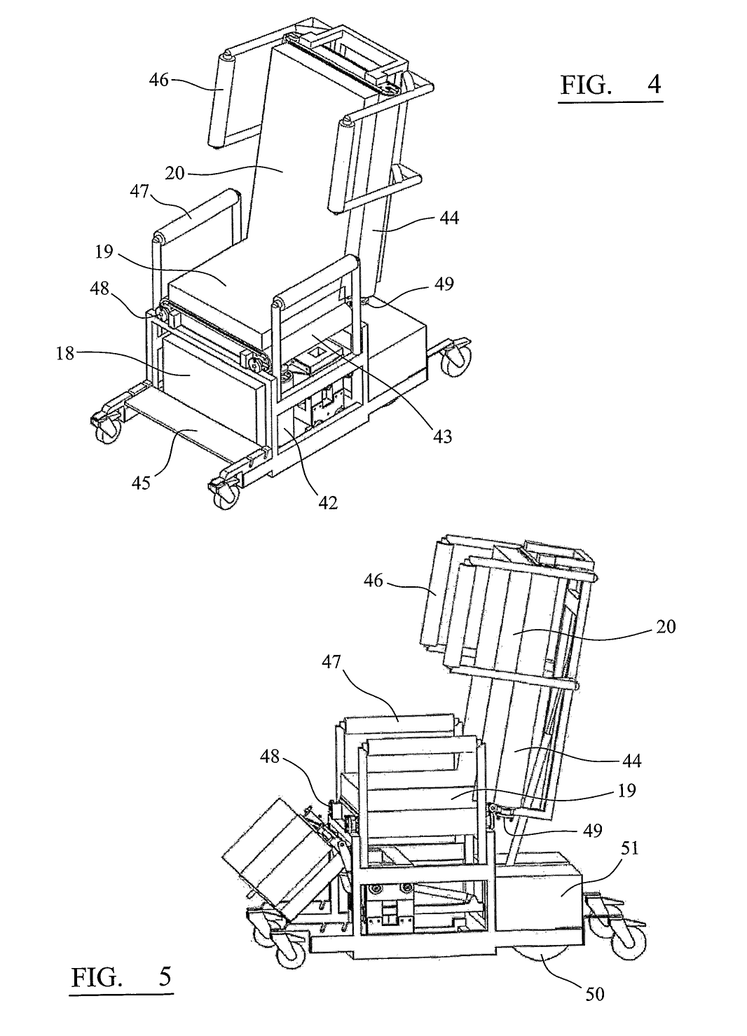

FIG. 4 shows the transfer table articulated so that the patient is in a seated position;

FIG. 5 is a side view of the transfer table shown in FIG. 4;

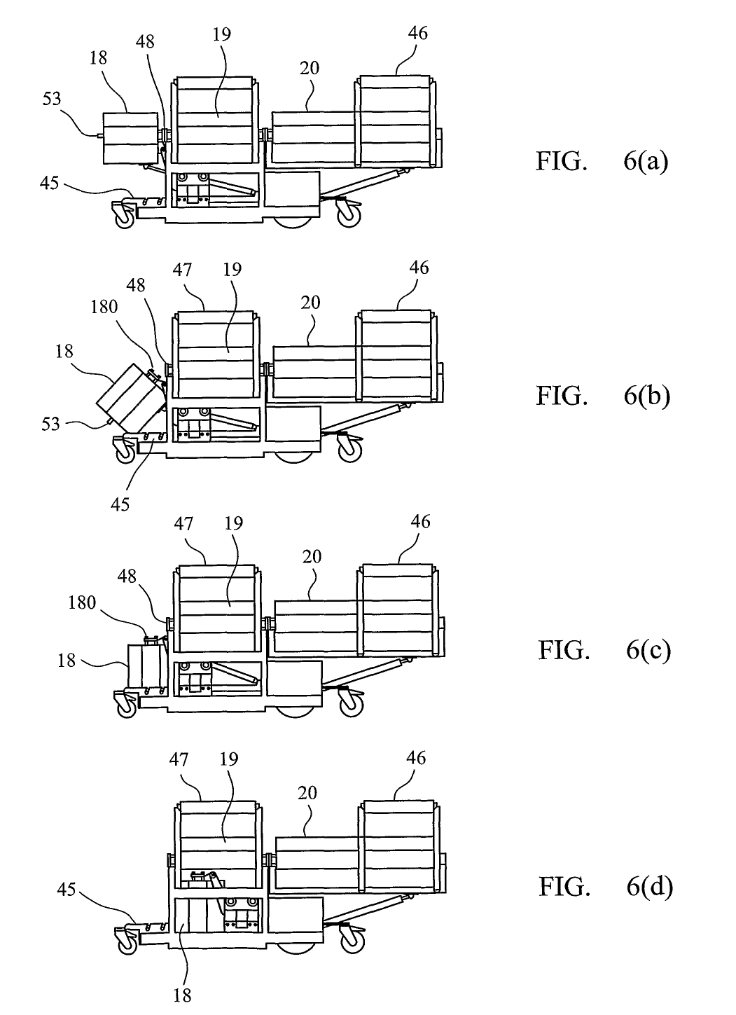

FIGS. 6(a) to (d) show stages of the retraction of the leg support of the transfer table;

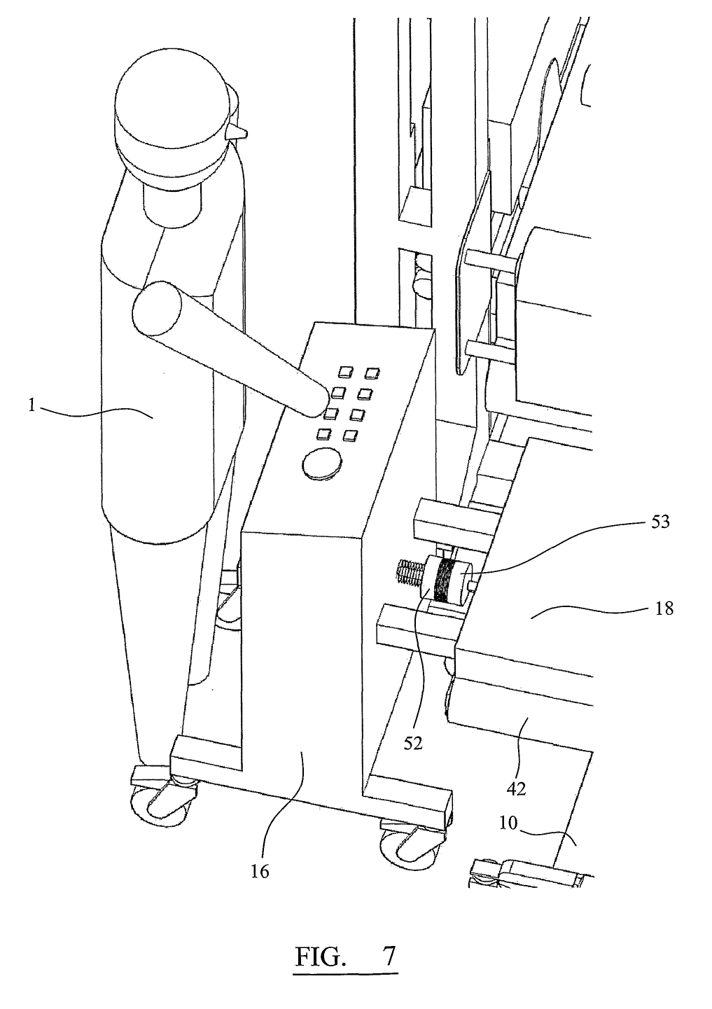

FIG. 7 shows the transfer table drive unit;

FIG. 8 shows the transfer table drive train of a first embodiment;

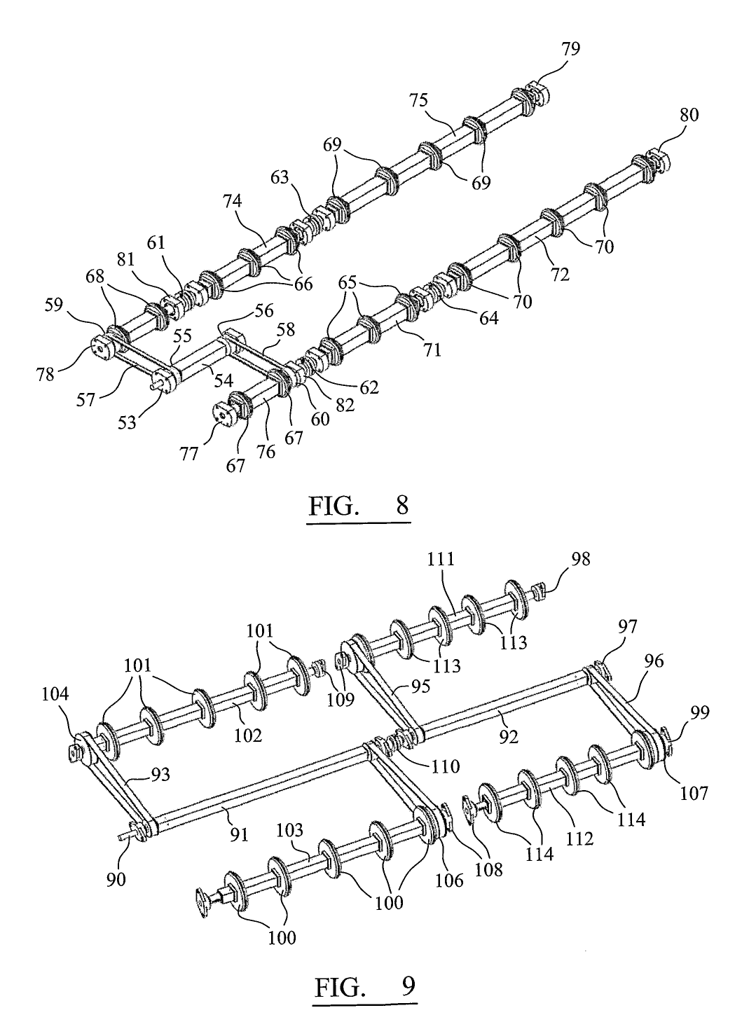

FIG. 9 shows the transfer bed drive train;

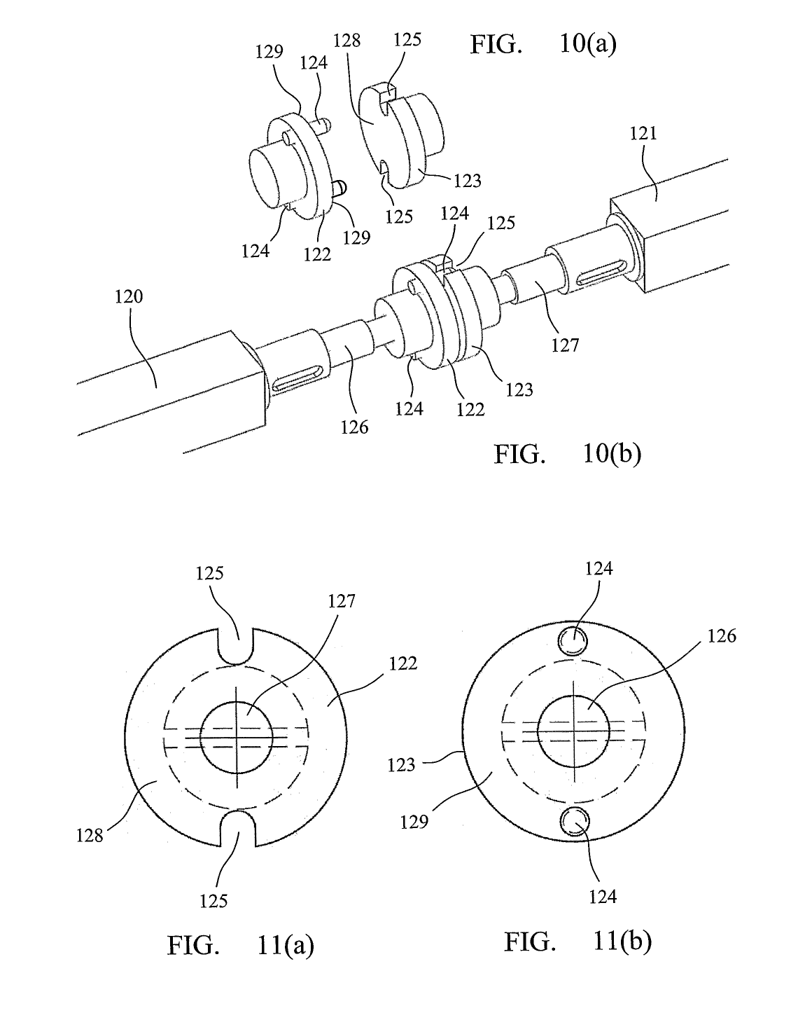

FIGS. 10(a) and 10(b) show the coupling for the drive train;

FIGS. 11(a) and 11(b) show the faces of the couplings;

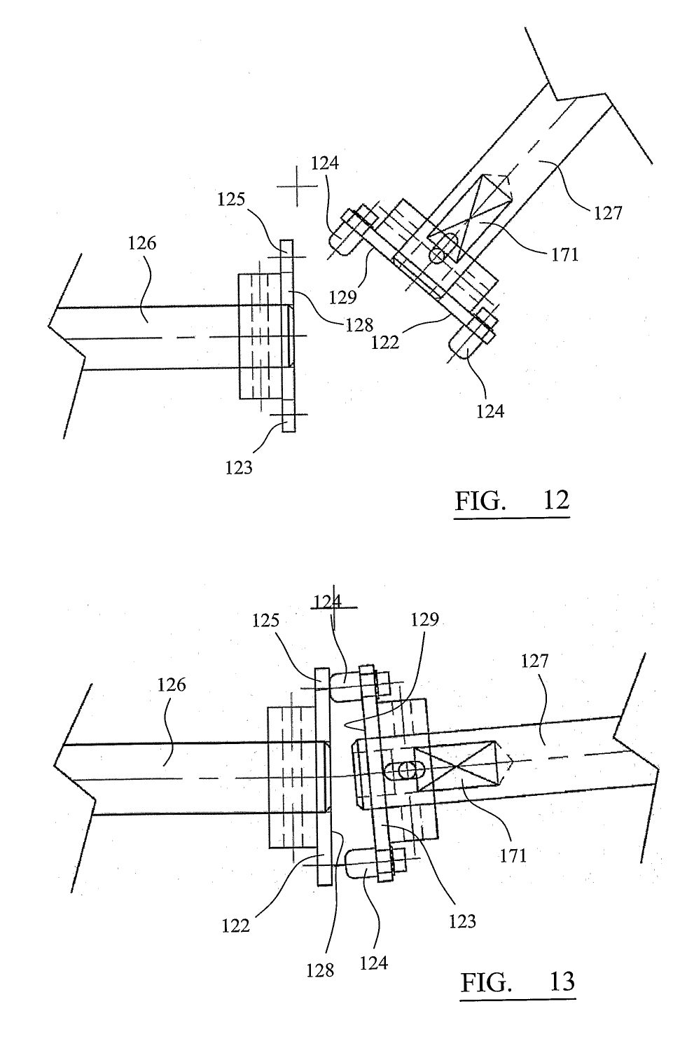

FIGS. 12 to 15 show stages of engagement of the couplings;

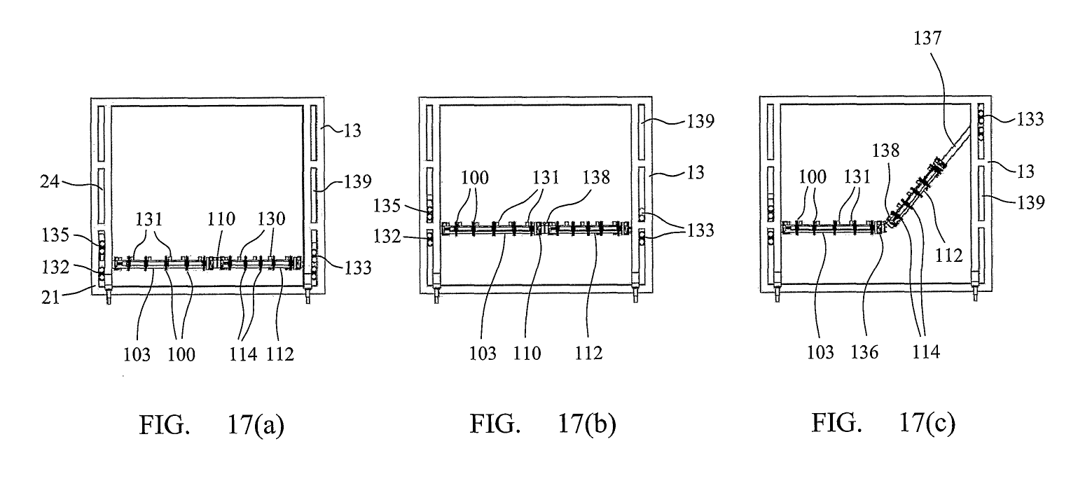

FIGS. 16(a) and (b) show the cantilever support system for the bed;

FIGS. 17(a) to (c) are a side elevation of the transfer beds shown in FIG. 16;

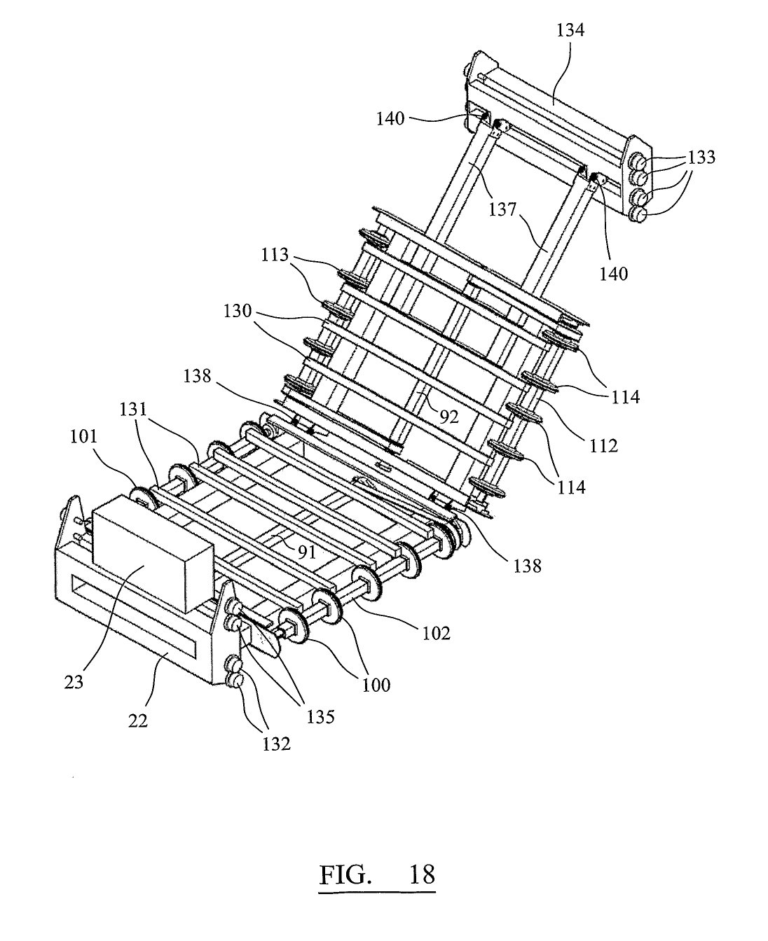

FIG. 18 is a perspective view of the head frame in an inclined position;

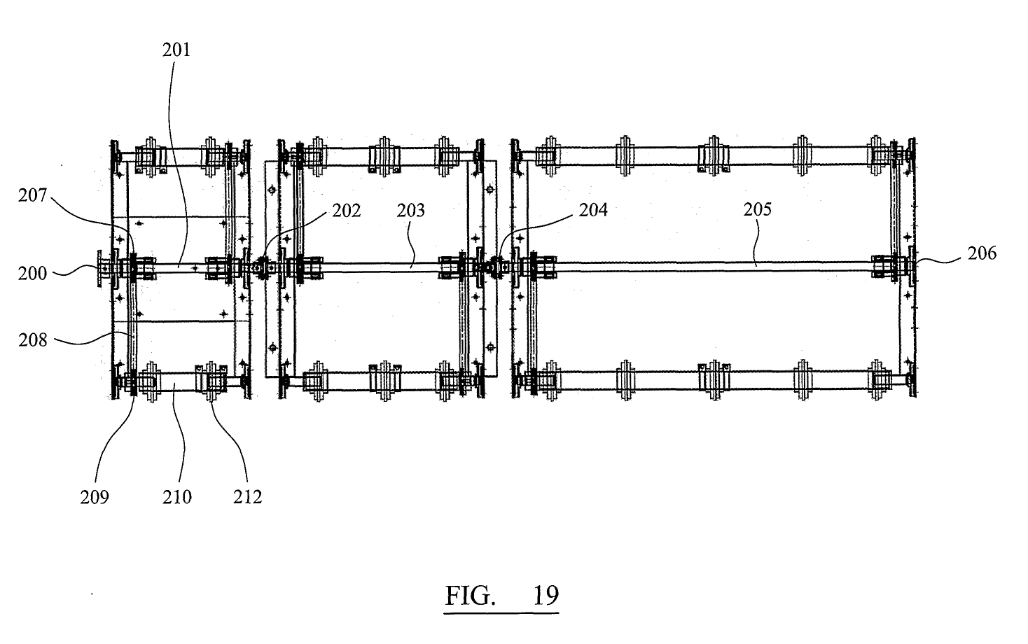

FIG. 19 shows the transfer table drive train of a second embodiment;

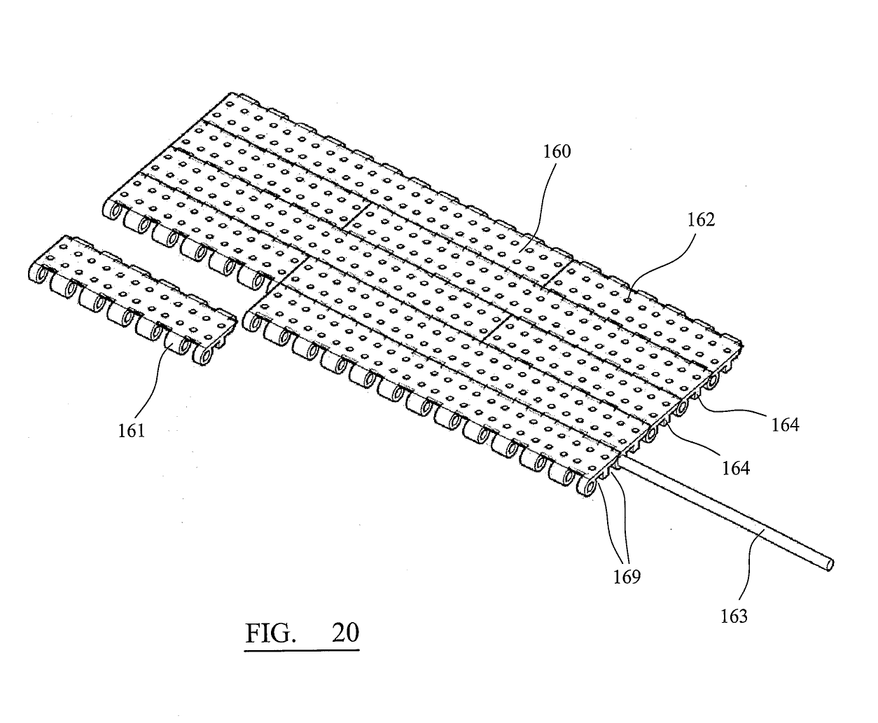

FIG. 20 illustrates components of a plastic modular conveyor belt;

FIG. 21 illustrates the conveyor belt and sprocket drive arrangement;

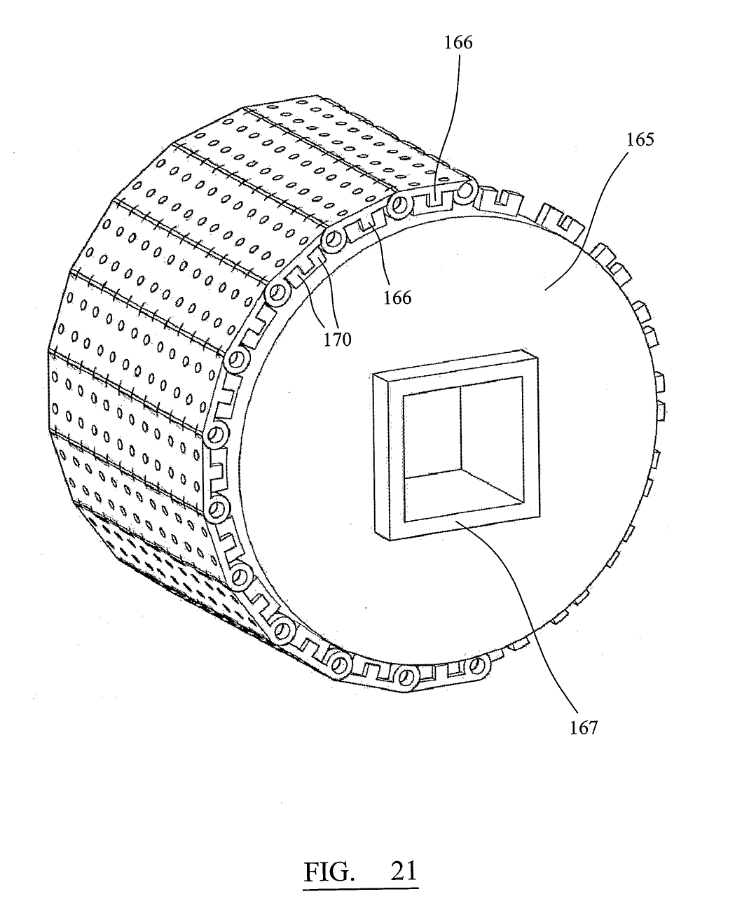

FIGS. 22 to 25 illustrate the conveyor actuator and drive mechanism;

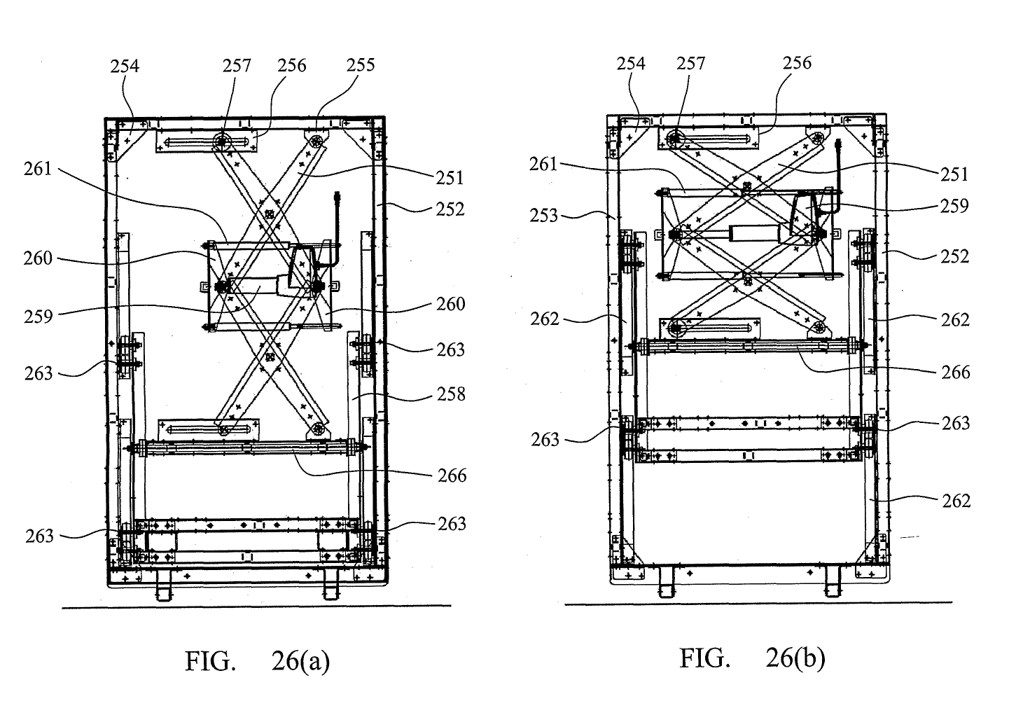

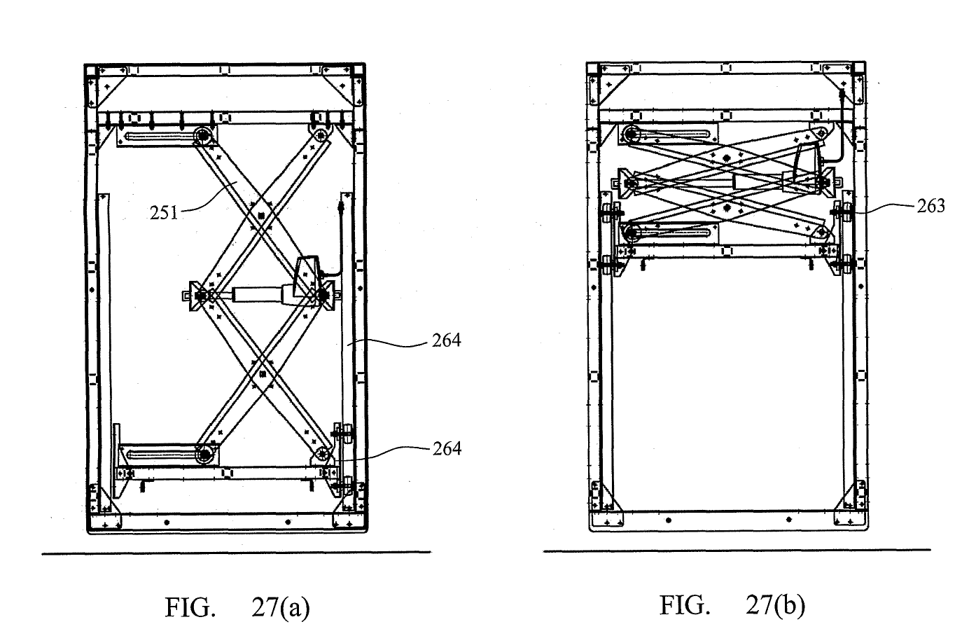

FIGS. 26 and 27 are end elevations of the lifting mechanism;

FIG. 28 is a sectional view of the mounting for the lifting mechanism;

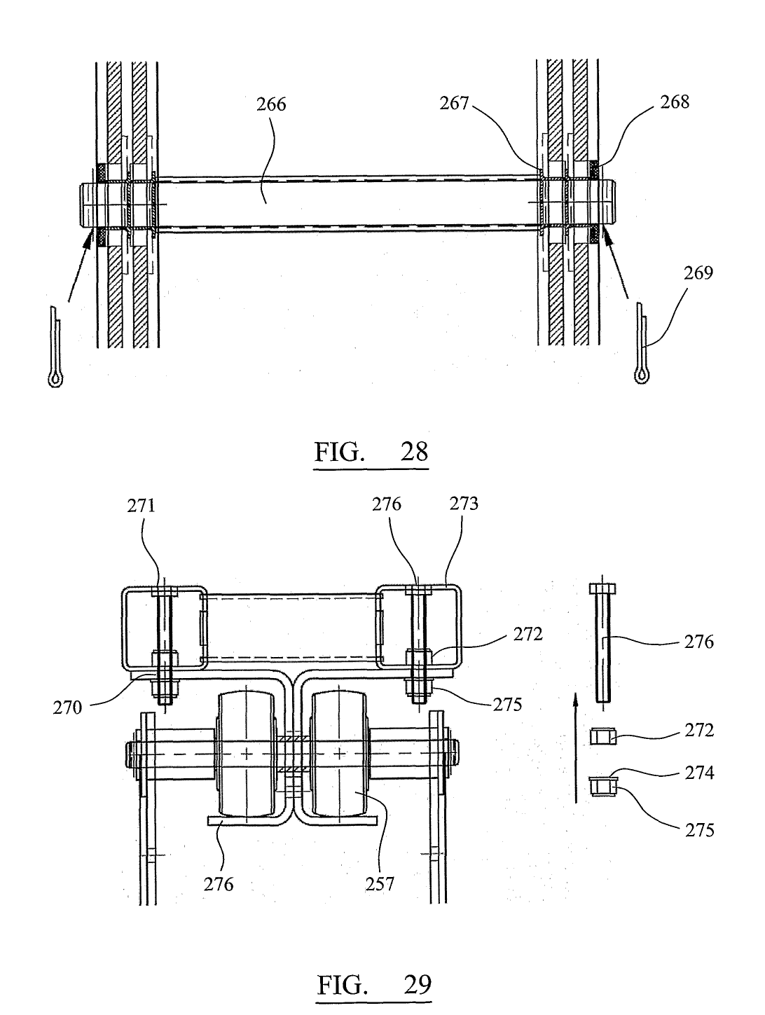

FIG. 29 is a sectional view of the fastening of the lifting mechanism to the bed frame;

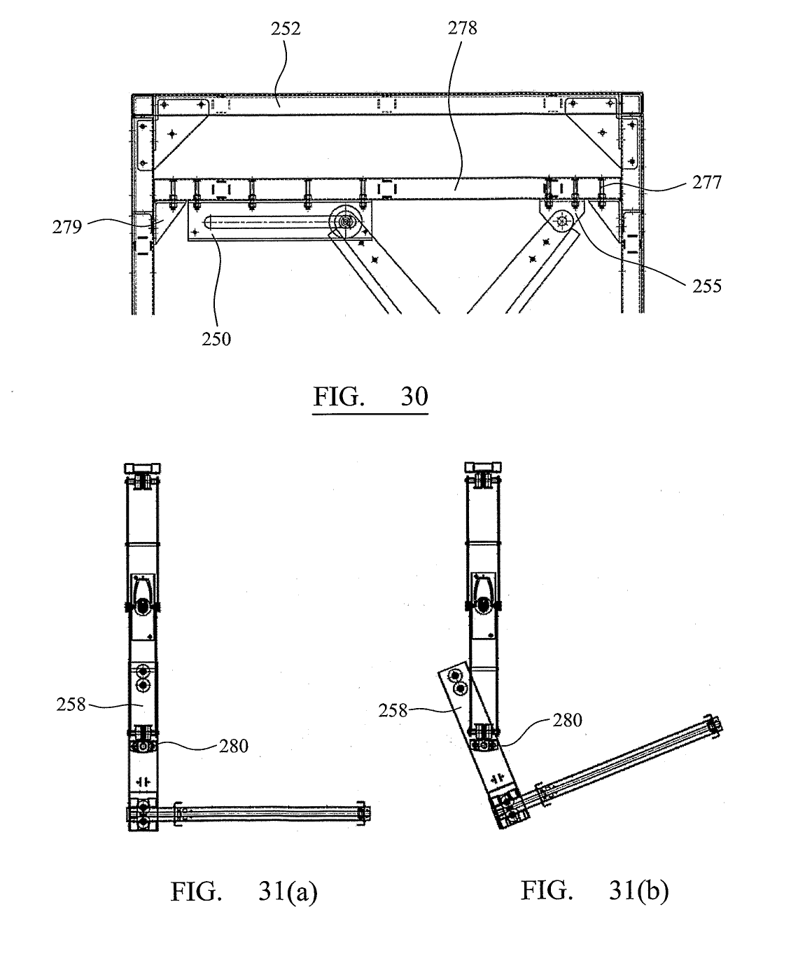

FIG. 30 is an end elevation of the attachment of the lifting mechanism to the bed frame;

FIG. 31 is a side view showing mounting of the leg frame carriage;

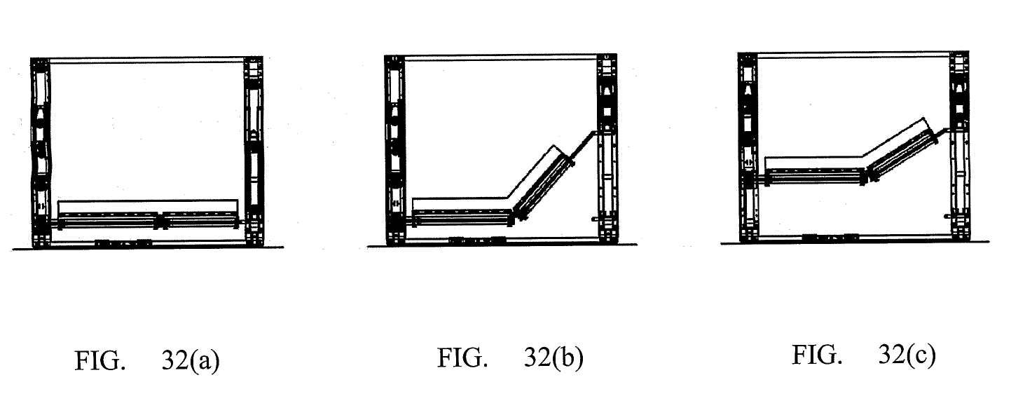

FIG. 32 is a side elevation of an alternative cantilever arrangement; and

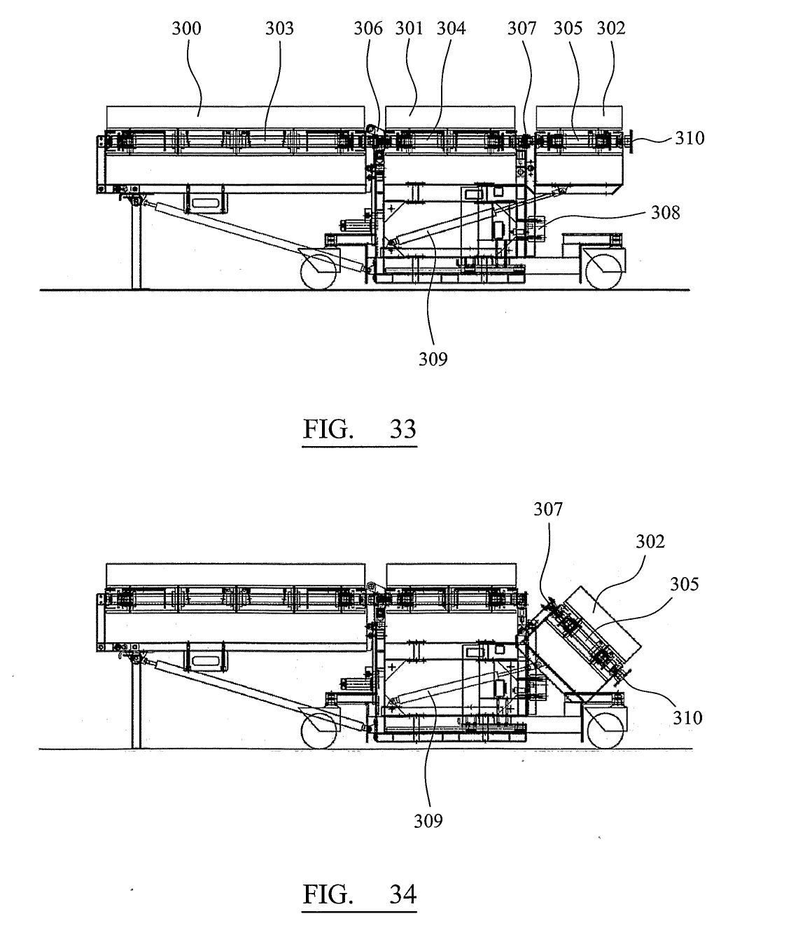

FIGS. 33 to 37 are side elevation views of a further transfer table.

FIG. 1 shows a perspective view of the patient transfer system in accordance with this invention. An operator or nursing assistant (1) is shown attending to an occupant (2) disposed on a bed (3). The bed has movable side safety bars (4, 5) mounted on upright members (13). The occupant is lying on a mattress (6) supported between rollers as described in more detail below. A transfer table (10) having a wheeled base (11) is engaged alongside the bed (3) and secured to the bed by a docking mechanism (not shown) (a suitable docking mechanism is disclosed in UK patent application No 0912629.3 filed 21 Jul. 2009 (attorney docket number ENG-P2143GB) the disclosure of which is incorporated herein by reference for all purposes)) so that the occupant may be safely transferred from the bed to the transfer table and vice versa. The foot frame of the bed (3) comprises a ground engaging base (12), four upright members (13) one located at each corner of the base (12) and an upper rectangular frame (14) connecting the upright members (13). An attachment for a hoist (15) is secured to the upper frame above the location of the transfer table (10). A transfer drive unit (16) mounted on a wheeled base and is adapted to engage the transfer table (10) to actuate the roller mechanism of the table (10). The drive unit (16) comprises a control panel and drive system with a drive coupling arrangement for connection to the transfer table (10). Both the mattress (6) of the transfer bed (3) and mattress (17) of the transfer table (10) have a rotating user support surfaces. The support surface of the bed (3) includes a mattress. The support surface of the transfer table comprises three separate support pads (18, 19 and 20).

The bed is attached to the frame at the foot frame member (21) and head frame member (25). The foot frame member (21) includes a sliding block (22) having a drive mechanism (23) mounted thereon. The sliding block (22) has rollers mounted in vertical runners (24) extending along inside faces of the upright members (26). Actuation of a driving mechanism (23) causes the conveyor to rotate. A motor drive unit (171) mounted on an upper part of the frame (14) is connected by cables to the sliding block (22) to raise or lower the sliding block. A motor drive unit (172) is similarly arranged to raise or lower the head portion.

In alternative preferred embodiments the head or foot frames may be raised or lowered by a scissor or double toggle lift arrangement driven by a linear actuator. The actuators or scissor arrangement may be located above or below the sliding blocks.

The bed is attached to the bed frame so that it may be raised and lowered and also so that the head portion may be inclined upwardly or restored to the horizontal. The foot portion is secured to the foot frame member (21) and the head portion is secured to the head frame member (25). The foot frame member (21) includes a sliding block (22) having a motor mounted thereon. The sliding block (22) has rollers mounted in vertical runners (24) on the inside faces of upright members (26). Actuation of the motor (171) causes the sliding block to be raised or lowered. Similarly the head portion is attached to a sliding block and may also be raised and lowered as explained in greater detail below. Alternatively and preferably a scissor lift or double toggle lift mechanism may be employed.

FIGS. 2(a) and 2(b) illustrate the construction of the mattress. A supporting foam layer (30) carries an upper memory foam layer (31). The support layer includes several V-shaped grooves extending in parallel longitudinally of the mattress to allow the mattress to be passed around a conveyor roller or sprocket (32) without loss of shape or support characteristics. The latitudinal V-shaped groove extends centrally of the mattress to allow the profiling of the mattress to be maintained the head portion is raised or lowered.

The apices (35) between adjacent grooves are truncated as shown or radiused to prevent splitting of the foam in use.

FIGS. 3(a) to 3(c) illustrate the stages of movement of an occupant from the bed to transfer table.

In FIG. 3(a) an occupant (2) is lying on the bed (3) and the transfer table (10) is secured along side the bed. The mattress (6) of the bed is located wholly on the upper surface of the bed and the three mattress portions (18, 19, 20) of the transfer table are rotated beneath the table. In FIG. 3(b) the operator has actuated the head portion conveyor (40) and foot portion conveyor (41) so that the mattress (6) is moved towards the transfer table and rotated beneath the bed. At the same time the transfer table conveyors (42, 43, 44) are moved in synchronised manner so that the support surfaces (18, 19, 20) are rotated from beneath the transfer table to form a continuously moving surface with the mattress (6) so that the occupant is carried smoothly towards the transfer table.

In FIG. 3(c) the occupant has been completely transferred to the transfer table. The mattress (6) is mostly located beneath the bed and the support surfaces (18, 19, 20) are supporting the occupant on top of the transfer table. The operator (1) may then disengage the transfer table from the bed and drive unit to allow the occupant to be moved to another location so that the transfer table may be articulated to a seated position.

FIGS. 4 and 5 show the transfer table in the configuration of a chair in this configuration the foot support portion (18) has been rotated so that it is stowed vertically under the seat portion (19). The back portion (20) is raised to a vertical or near vertical position to support an occupant's back. Side rails (46, 47) are raised to support a user's body and shoulders. A foot rest (45) supports an occupant's feet, relieving pressure between the occupant's calves and heels and the foot support pad (18). Couplings (48 and 49) are disengaged but re-engage when the transfer table is brought to a horizontal configuration so that the conveyors may be actuated to transfer an occupant back onto a bed. A drive wheel (50) is powered by a motor (51) in order to move the table between different locations.

FIG. 6 shows the stages of retraction and stowing of the leg portion of the transfer table.

In FIG. 6(a) leg portion (18) seat portion (19) and head/back portion (20) form a horizontal support surface into which an occupant may be moved from a bed by actuation of the conveyors. Driving force for the transfer table conveyors is applied through a coupling (53) to rotate the support surface (18) as previously described.

To move the transfer table into the chair configuration, the drive means is disconnected from the coupling (53) and the leg portion is rotated anticlockwise as shown so that the foot part moves downwardly and the coupling (48) is disengaged. The male portion (180) of the coupling is shown with two projections disengaged from the seat portion drive mechanism.

The axis of rotation of the leg portion is preferably arranged to generally coincide with the axis of rotation of an occupant's knees. In this way undue pressure is not exerted on an occupant's knee joints during stowing of the leg portion or returning the leg portion to the horizontal position.

In FIG. 6(c) the leg portion is rotated into a downward position. In this position an occupant's calves and heels will contact the support surface (18). The support surface is then slideably moved on bearings to a position beneath the seat (19) as shown in FIG. 6(d). A foot rest (45) supports the sole of the occupant's feet In this position the support surface (18) is located completely beneath the seat (19) so that an occupant can sit comfortably without his calves touching the support. The support (18) is preferably located a sufficient distance behind the slot so that different sizes of cushions may be used to accommodate occupants of different physical sizes.

Although the back/head support is shown horizontal in FIG. 6 it will be appreciated that it can be moved to an upwardly inclined position at any convenient stage of the procedure described above.

FIG. 7 shows a separately mobile transfer table drive unit (16) which may be releasably coupled to the transfer table (10) by means of respective couplings (52, 53) so that power for actuation of the transfer table may be transmitted from a motor (not shown) in the drive unit (16) to the transfer table. In an alternative embodiment, the transfer table has an internal drive and control unit so that the drive unit (16) can be omitted.

FIG. 8 shows a first drive mechanism for the transfer table. A coupling (53) (shown in FIG. 6) connects in use to the drive unit (16). Coupling (53) is connected by main drive shaft (54) to pulley wheels (55, 56). Pulley belts (57, 58) are connected to pulleys (59, 60) of conveyor drive shafts (73, 76) of the leg portion of the transfer table. The diameter of the pulleys or sprockets (55, 56) is preferably less than the diameter of the pulleys or sprockets (59, 60) to impart a suitable mechanical advantage. Sprockets (67, 68) engage an endless modular conveyor belt (not shown) to rotate the foot portion mattress. Bearings (77, 78) and (81, 82) allow rotation of the shaft (73, 76) in use. Spring loaded couplings (61, 62) allow the driving force to be transmitted to seat portion shafts (71, 74) and sprockets (65, 66), when the transfer table is in the horizontal orientation. When the transfer table is moved into the seated position the couplings (61, 62) are disengaged as shown in greater detail in FIG. 9.

Couplings (63, 64) allow the driving force to be transmitted to head portion shafts (72, 75) and sprockets (69, 70). The couplings (63, 64) have a similar configuration to the couplings (61, 62) and are disengaged when the head portion is moved from the horizontal to an inclined or vertical orientation. Bearings (79, 80) allow rotation of the shafts (72, 75) and (71, 74) and driving force is applied to the coupling (53) and drive shaft (54).

In this arrangement the sprockets (67, 68, 65, 66) and (69, 70) are driven so that the upper and lower parts of the conveyor belt loop are tensioned in use.

FIG. 9 shows the drive mechanism for the head and foot portions of the bed. A drive shaft (90) for a motor (not shown) is directly coupled to main drive shaft (91) extending axially longitudinally of the foot portion of the bed. Drive belts (93, 94) communicate with pulley wheels (104, 106) to conveyor drive shafts (102, 103) and sprockets (100, 101). An endless modular conveyor belt (not shown) passes over sprockets (100, 101) and is positively driven at both ends so that the upper surface is maintained under tension in use. The shafts (102, 103) are mounted in bearings (109, 108).

A spring loaded coupling (110) is shown in more detail in FIGS. 11 to 15. The coupling transmits the driving force from main shaft (91) to main shaft (92) when the bed is in the horizontal orientation. Belts (95, 96) and pulleys (105, 107) transmit the driving force to shafts (111, 112) and sprockets (113, 114). The coupling (110) is arranged to be disengaged when the head portion is raised and re-engaged as the head portion is returned to the horizontal orientation as described with reference to FIG. 9. Couplings (61, 62, 63, 64 and 110) of FIG. 8 or (108, 109) of FIG. 9 are shown in greater detail together in FIGS. 11 to 15 with their input drive shafts. The coupling comprises a pair of engagement discs (122, 123) mounted on spring loaded extensible ends of the drive shafts (126, 127) adapted to contact each other when the coupling is engaged. The discs have mating surfaces (128, 129). A first disc preferably the driving disc connected to the motor has two forwardly extending studs (124) arranged to be received in corresponding apertures (125) in the driven disc (123), when the head or foot portions of the bed or transfer table are brought into alignment in the horizontal configuration. The apertures (125) may extend radially outwardly of the disc in diametrically opposed configuration. The apertures preferably comprise slots extending completely through the thickness of the disc. When the discs (122, 123) are brought into general alignment, the rotation of disc (122) causes the studs (124) to pass across the surface (128) of disc (123) until the studs (124) engage within the slots (125) to complete the coupling. The two discs can then engage to form a secure coupling through which driving force may be transmitted to the conveyor.

In a preferred embodiment the studs (124) are spring loaded and are provided with domed ends to facilitate insertion into the slots (125).

FIGS. 16 to 18 illustrate the cantilever arrangement. The drive arrangement for rotation of the conveyor is shown in FIGS. 6 and 7.

FIGS. 16(a) and 16(b) show the bed conveyor arrangement with the endless belt and mattress removed. The foot portion is secured and supported by the sliding block (22) which is mounted for vertical movement in the upright member (26) by means of rollers (132, 135) movable in the slots (24). The foot portion extends horizontally from the sliding block and is supported to prevent downward movement under the load of the head portion and/or occupant weight.

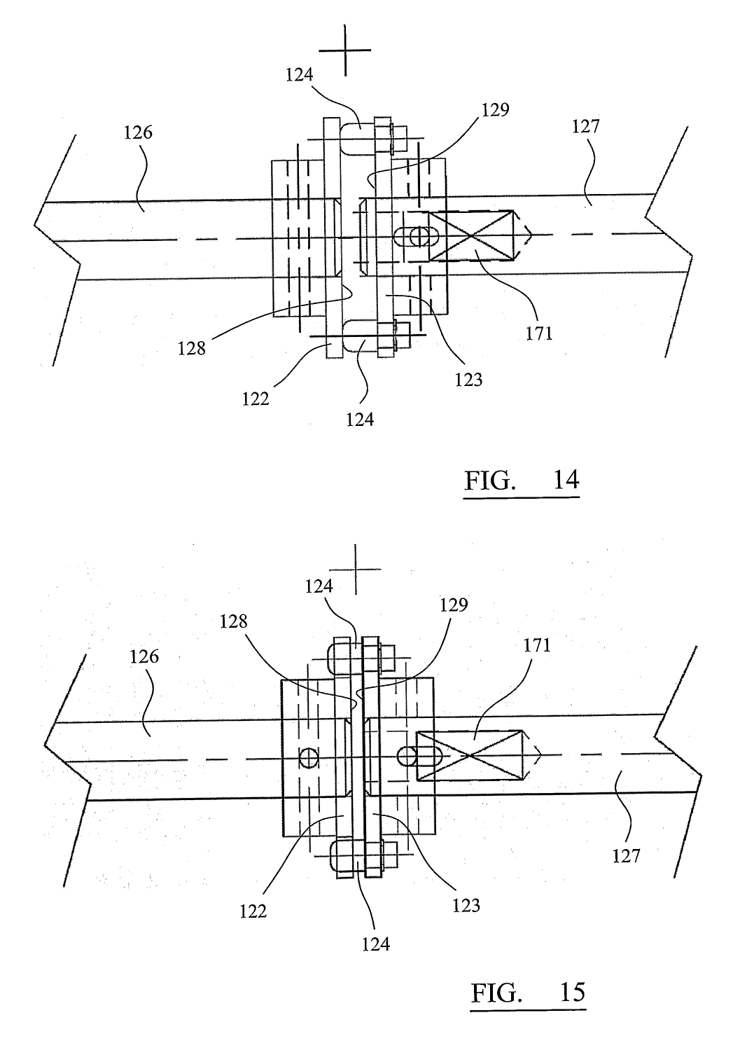

The upper part of the head portion engages a sliding block (134) by means of a hinge and extendible members as shown in FIG. 13. Support beams (130,131) extending cross-wise of the bed support the under surface of the conveyor to prevent sagging during use.

FIGS. 17(a) to (c) show the arrangement in side elevation illustrating the movement of the bed portions.

In FIG. 17(a) the bed portion is at a lower position close to the floor. The foot portion is rigidly mounted by engagement of rollers (132, 135) in the guideway (24) of upright member (21). The head portion is securely engaged in the upright member (13) by reception of the rollers (133) in the bed end upright members. The lower end of the head portion is supported by attachment of the hinge (138) secured to the cantilever structure of the lower portion.

In FIG. 17(c) the head sliding block and rollers (133) is moved upwardly while the foot portion rollers (132, 135) remain in the position shown in FIG. 11(b). Extensible members (137) connected to the sliding block and rollers (133) by means of a hinge, extend from the head portion to secure the head portion in an upwardly inclined position. The hinge (138) allows rotation of the head portion relative to the cantilever structure provided by the foot portion and the coupling (136) disengages at this time.

FIG. 18 is a perspective view showing the arrangement of FIG. 17(c) the head portion is connected to the foot portion by means of hinges (138). Extensible members (137) and received in sockets or channels in the head portion are connected by hinges (140) to the sliding block (134) so that the sliding block may be moved upwardly or downwardly to incline the head portion or restore it to the horizontal as required.

FIG. 19 illustrates an alternative drive mechanism for a transfer table. The drive mechanism differs from the mechanism shown in FIG. 8 in that a coupling (200) comprising a female disc (122) as shown in FIG. 11 is connected to a main drive shaft (201) extending longitudinally axially of the foot portion to connect in turn via a coupling (202) to a main drive shaft (203) extending axially of the seat portion and further coupled in turn via coupling (204) to a main axially extending shaft for the back/head portion and culminating in a bearing (206). The main shafts (201, 203, 205) are connected by sprockets eg chains (208) and driven sprockets (209) to conveyor shafts (210) having conveyor driving sprockets (211, 212) as previously described with reference to the main bed conveyor illustrated in FIG. 9. The sprockets are connected to their respective drive shafts using a friction locking assembly, for example a Ringfeeder RfN series assembly to enable each set of conveyor sprockets to be precisely and independently aligned with the other sprockets. The conveyor shaft sprockets may be fixed to the conveyor shafts via traditional taper bush and keyway fixings.

The drive chains used may be suitably rated self-lubricating simplex ISO/BS chain, for example Renold Syno chain and tension may be maintained during forward and reverse drive by fitting a Roll-Ring Chain Self-Adjusting Tensioner. The bearings used on the drive shafts and conveyor shafts may be ball bearings in flanged housing or more preferably self-lubricating plastic polymer bearings in flanged plastic polymer housings in order to achieve a lightweight construction.

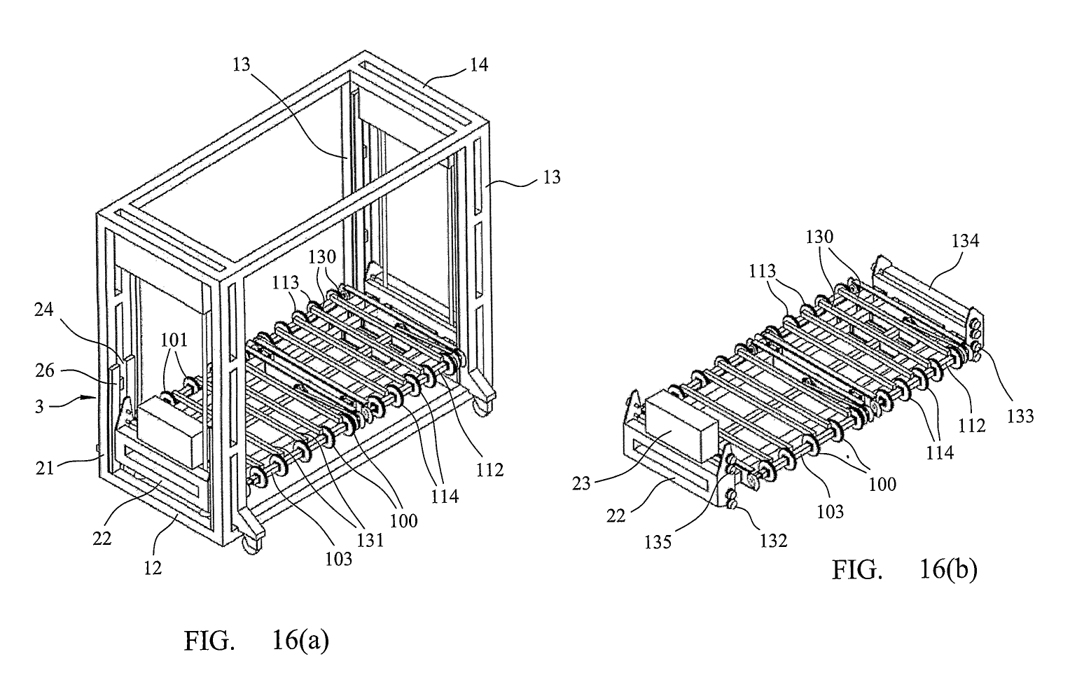

FIG. 20 shows part of a modular belt conveyor. The belt is composed of plastic modules (161) connected by pins (163). The pins have a semi-permanent location device on either end to keep them in position when the belt is in use. The length of the module determines the pitch of the belt and the width of the modules when combined produce a desired width of belt. Each module has a transverse projection (164) extending downwardly to engage teeth of a sprocket as shown in FIG. 15.

FIG. 21 the sprocket (165) has radially outwardly extending teeth (170) to engage the projections (166). The sprocket includes a rectangular axial socket to receive a driving bar e.g. (112).

A positive engagement between the sprocket and conveyor modules enables the belt to be positively driven in contrast to a conventional friction driven belt between the belt and driving rollers. The use of a plastic modular belt allows the mattress or pad cover to be fixed semi-permanently using a variety of fixing methods. Plastic modular belting provides a durable and suitable fixing point to which a mattress or support pad can be attached and suitable belts may be manufactured by Forbo Seigling and Intralox.

The modules have an array of holes (162) to allow air flow through the belt to assist in keeping a mattress and other support pads dry and cool in use. Alternatively solid modules may be used throughout the belt to allow easier cleaning.

FIGS. 22 to 25 illustrate the linear drive and rocker tensioner of the drive mechanism (shown generally at 23 of FIG. 1).

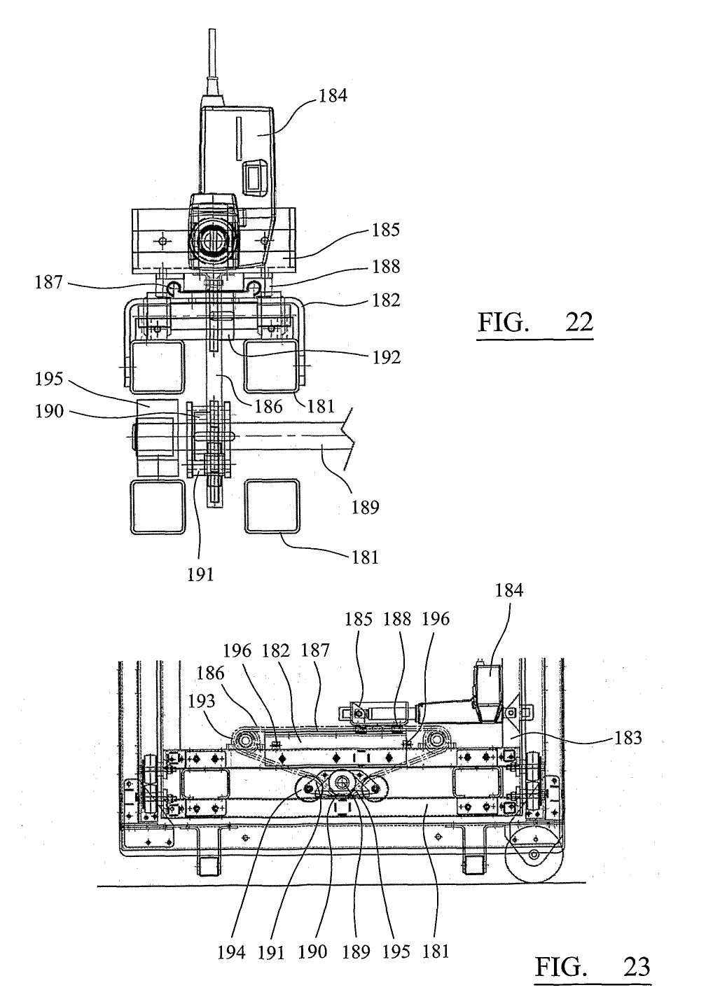

FIG. 22 shows in a side view the main elements of the linear drive and rocker tensioner arrangement used in the drive mechanism. A similar configuration of linear drive and rocker tensioner arrangement may be used in both the bed and transfer table drive units to provide rotational drive to the bed and transfer table conveyors respectively. Different actuator strokes and sprocket ratios are selected to ensure the speeds of the two units match. The bed linear drive comprises a square or rectangular hollow section linear drive frame with a mounting plate attached. The linear drive frame (181) is mounted inside the leg frame carriage (183)—See FIG. 23). A linear actuator (184) is fixed to the leg carriage frame (183) and a slide bracket (185). The slide bracket is attached to a transmission chain (186) and precision linear slide rail (187) via four plastic polymer linear bearing blocks (188). The actuator may be electric, hydraulic, pneumatic or hand operated. An electric actuator is preferred. The stroke length of the actuator dictates the number of revolutions the main conveyor drive shaft (189) will achieve during a transfer. The conveyor drive shaft is supported to prevent excessive overhung load by a suitably rated pedestal type ball bearing unit (195).

The main conveyor drive shaft (181) has a sprocket (190) fitted using a taper lock bush and keyway, around which is mounted a rocker tensioner (191). The transmission chain (186) attached to the slide brackets (195) is endless and runs over two adjustable tension sprockets (192) mounted between pairs of pedestal type ball bearing units or plastic polymer self lubricating pedestal bearing units, through the rocker tensioner and around the main conveyor drive shaft sprocket (189). The pedestal type ball bearing units have slots for the fixing fasteners and as such can be adjusted using jacking screws fitted into jacking blocks (196) to increase or decrease pre-tension on the transmission chain (186).

FIG. 23 shows an end view of the linear drive and rocker tensioner (191) arrangement. The linear actuator (184) is in its fully retracted position. The rocker tensioner (191) is free to pivot on the main conveyor drive shaft 189) and comprises of two idler sprockets (194) with integral ball bearing running on fixed shafts between two plates. The tensioner serves to remove slack from the transmission chain. This improves responsiveness when the drive is reversed in direction.

FIG. 24 shows that as the linear actuator (184) extends its rod the transmission chain (186) will become taut on the trailing side of the slide bracket (185). To ensure that the chain remains in contact with the required number of teeth on the conveyor drive shaft sprocket (190) the rocker tensioner (191) pivots on the conveyor drive shaft (189) in response to the transmission chain being pulled in tension. When the linear actuator (184) begins to retract its rod the rocker tensioner (191) pivots in the opposite direction to accommodate the change in transmission chain (186) direction.

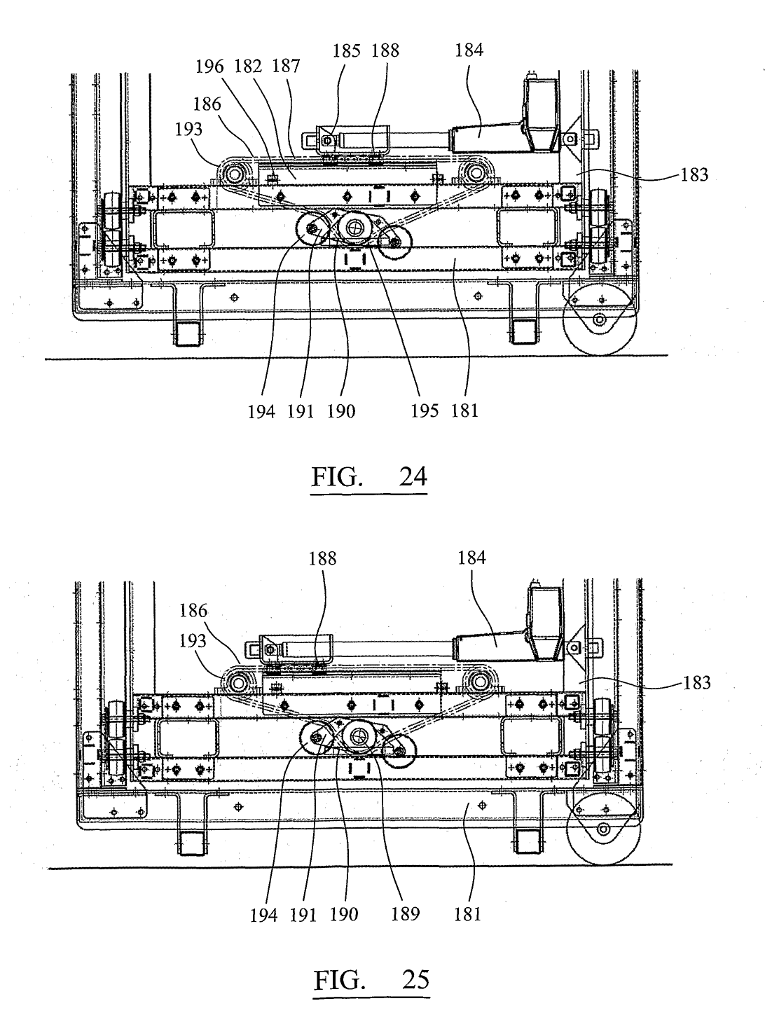

FIG. 25 shows the linear actuator (184) fully extended at the end of its stroke. At this point the conveyor drive shaft (189) has completed the required number of revolutions to turn the bed mattress over the conveyor to accomplish a safe and effective transfer.

An important feature of the linear drive is that it prevents a user turning the conveyor drive shaft (189) too far in either direction as the movement is consistently limited in both directions by the stroke of the linear actuator.

By selection of the stroke length and sprocket ratios throughout the linear and conveyor drive a safe and comfortable mattress transfer speed can be achieved. In addition, as the transfer table drive unit utilises the same linear drive and rocket tensioner arrangement, the stroke and sprocket ratios may be selected to match the speed of the transfer table pads as closely as possible to that of the mattress and produce the required amount of rotary motion to complete a safe and comfortable transfer.

FIGS. 26 to 32 show the lifting arrangement in greater detail.

As shown in FIG. 26 the lifting arrangement comprises eight scissor arms (251) arranged in two sets of four in scissor lift or toggle lift arrangements (each referred to for simplicity as scissor lift). Each scissor lift is attached to the bed frame (252) and relevant carriage. The bed frame is constructed of a suitably rated square or rectangular steel hollow section (253) and is further strengthened by the addition of corner plates (254) fitted at both ends of the frame in all four corners. FIG. 26 shows the scissor lift arrangement for the leg end of the bed. The scissor arms (251) are pivotally connected to the bed frame at the top by a pair of scissor arm hinge brackets (255), scissor wheel brackets (256) and scissor wheels (257). The scissor arms (251) are connected to the leg frame carriage (258) by the same arrangement. The scissor arm hinge brackets are fitted with a suitably rated self lubricating bearing (267), such as an oil impregnated phosphor bronze or plastic polymer bearing. The bearing ensures that when the scissor arms pivot on the hinge bracket that they do so with the minimum amount of friction and wear ensuring the scissor lift mechanism is virtually maintenance free. The scissor arms are connected to the scissor arm hinge brackets in the same way as the scissor arms are connected at other hinge points throughout the mechanism (see FIG. 28 and relevant explanation of bearing, spacer and split cotter pin location method below). Each scissor wheel (257) is in one embodiment a cast Nylon wheel fitted with two precision ball bearings with integral spacer. Use of Nylon ensures a quiet and smooth operation with minimum wear between wheel and bracket and the precision ball bearings ensure the friction during movement of the wheels is kept to a minimum.

An actuator (259) is centrally mounted on a pair of actuator brackets (260) which is used to open or close the scissor arms by extending or retracting the actuator.

When the actuator (259) is extending the angle between scissor arms decreases and the load connected to the base of the scissor lift is raised. When the actuator (259) is retracting the angle between the scissor arms increases and the load connected to the base of the scissor lift is lowered.

The actuator may be electric, hydraulic, pneumatic or hand operated. An electric actuator is preferred. The stroke length of the actuator dictates the vertical distance the load connected to the scissor lift will be raised and lowered. Where the load requires a corresponding pushing force from the actuator (259) that is approaching the safe working load of the actuator (259) a pair of gas springs (291) are fitted at opposing corners of the actuator brackets (260). The gas springs are the push type which produce a relatively constant force against the actuator brackets (260) throughout the stroke of the actuator (260). The force of each gas spring is matched and set to eliminate the effect of the load of the unloaded carriage which the lifting mechanism is carrying at the lowest vertical position of the carriage. Typically (although not exclusively) the lifting mechanism at the leg end of the bed is fitted with gas springs as it is the leg end carriage that is connected to the cantilever beams that support the majority of the rotating sleep surface mechanism and user load. As an additional safety feature when using certain types of linear actuator, particularly electrically powered actuators, a safety nut is employed. In actuators where a typically low voltage, electric motor turns a series of gears to rotate a drive nut that then produces the linear motion of a rod, is a safety nut is incorporated. This is used because the pushing or pulling force of the actuator rod is generated by turning the original drive nut. A safety nut is incorporated to ensure that if the original drive nut fails the rod will not retract (or extend). In a preferred embodiment of the invention such an actuator is fitted to ensure that the lifting mechanism is single fault safe. This means that if the original drive nut of the actuator fails (a single fault) the load will still remain in the same position due to the intervention of the secondary safety nut. A supplier of linear actuators with this safety nut feature fitted are manufactured by Linak.

FIG. 26(a) shows the leg frame carriage in the lowest position. This typically would result in the top of the mattress having a height from the floor of approximately 500 mm. It is a feature of the rotating sleep surface transfer system that the normal height at which the leg frame of the bed should be set may be 500 mm to the top of the mattress. This distance is chosen for three reasons. A distance of 500 mm to the top of the mattress allows direct transfers using transfer boards in the case of emergencies. Also in the event of unforeseen circumstances that result in a user falling from the mattress, 500 mm is a safer distance to fall than from higher beds designed for ease of servicing the user by the carer (typically 700-900 mm to the top of the mattress). Most importantly the 500 mm top of mattress height is selected to be the lowest position of the leg end scissor lift mechanism. This means that even if the original drive nut and the safety nut of the scissor lift actuator failed, or there was a catastrophic failure, however unlikely of the scissor lift mechanism, the leg frame carriage would have no vertical distance to fall. The risk of potential injury to the user would therefore be completely negated if the top of mattress height was maintained in normal use at 500 mm. Where the leg frame height is adjusted for user servicing and transfer purposes the linear actuator system still remains single fault safe due to the inclusion of the safety nut.

FIG. 26(b) shows the leg frame carriage in the highest position. This would result in a top of mattress height of approximately 900 mm.

During lifting the leg frame carriage is held in place by a two pairs of carriage support angles (262). The leg frame carriage is fitted with two pairs of carriage wheels (263) either side that run up and down the face of the carriage support angles (262).

FIG. 27 shows the lifting arrangement for the head end of a bed. In this embodiment of the invention the head end scissor lift only carries a small proportion of the overall load on the rotating sleep surface system and therefore it may not be necessary to use gas springs. If the user load of the system was increased, for instance for use by bariatric users, then gas springs could be fitted to reduce the starting load on the linear actuators. FIG. 27 (a) shows the head frame carriage (264) in the lowest position resulting in a flat top of mattress height of approximately 500 mm and FIG. 27(b) shows the head end in its highest position resulting in an inclined mattress support surface at an angle of approximately 48 degrees. The overall vertical lift height of the head frame carriage is approximately 900 mm. As the head frame carriage typically is subjected to a much smaller cantilevered load than the leg frame carriage it is only fitted with one pair or carriage wheels (263) on either side.

FIG. 28 shows a side view of the scissor arms sets and that they are separated by means of scissor arm pins (265) and spacers (266). The scissor arms are fitted with a suitably rated self lubricating bearing (267), such as an oil impregnated phosphor bronze or plastic polymer bearing. The bearing ensures that when the scissor arms pivot that they do so with the minimum amount of friction and wear ensuring the scissor lift mechanism is virtually maintenance free.

In addition the scissor arm pins (265) are fitted with a flat washer (268) and split cotter pin (269) at either side. The split cotter pin is located in a hole drilled in the end of each scissor arm pin (265). The flat washer (268) turns against the flange of the self lubricating bearing (267) to ensure that the split cotter pin (269) does not wear. It is a feature of the invention that when the split cotter pin (269) is correctly fitted and the end is bent around the scissor arm pin (265) in the accepted manner of fitting that it provides a very secure method of location of the scissor arm pin (265) as it would have to be sheared off with an extremely high lateral force that in normal operation is not present within the lifting mechanism.

The method of fastening the scissor lift mechanism to the bed frame is also a feature of the invention. FIG. 29 shows where a part such as the scissor wheel bracket (256) is to be fastened to the bed frame a specially adapted fastener is used. The hollow section (273) used in the construction of the bed frame is drilled, punched or laser cut to produce two opposing holes where the adapted fastener is required. The hole nearest to the face of the tube where the part is to be attached (270) is slightly larger than the main diameter of the fastener (eg 8.5 mm diameter hole for a standard M8 threaded fastener). The hole in the opposing face of the tube (271) is either round (where socket cap head fasteners are to be used) or hexagonal (where hexagonal head fasteners are to be used). A shear nut (272) typically an anti vibration plastic insert nut is screwed onto the chosen fastener (276) up to a point where the fastener is placed into the large round or hexagonal hole the head of the fastener and is flush with the outer face of the tube when the shear nut meets the inside face of the tube. The length of the fastener is then varied to produce different thread lengths protruding out of the face of the tube where the part is to be attached—as required for normal fastening by a flat washer (274) and anti vibration plastic insert nut (275). It is a feature of this adapted fastener that when the part attached produces a load on the fastener there is the added shear strength of the shear nut acting against the inside wall of the tube. Where required the head of the fastener in the opposing side of the tube can be welded into place for additional strength. Another feature is when the adapted fastener is used to fix a part that is producing a cantilevered load on the adapted fastener and tube such as the carriage support angles the load is equally shared on the tube on the two opposing faces on the tube, which is critical where thin walled hollow section tubes are used to reduce the overall weight of the rotating sleep surface system.

FIG. 30 shows how multiple adapted fasteners (277) are used to attach the scissor arm hinge brackets (255) and scissor wheel brackets (6) to the bed frame (2). Where the bed frame beam (278) that the scissor lift is attached to is not fitted with corner plates because of its vertical position corner support angles (279) are fitted to attach the bed frame beam to the bed frame.

FIG. 31 is a side view showing that when the scissor lift is connected to a load that may be cantilevered, such as the leg frame carriage (258), there may be a tendency for the scissor arm bearings to be put under a side load. This could dramatically reduce the service life of the bearings, and increase the friction in the scissor lift mechanism, resulting in additional force being required from the actuator (259). FIG. 31(a) shows the leg frame carriage (258) in the normal cantilevered position. FIG. 31(b) shows the leg frame carriage (258) in a greatly exaggerated rotated position for the purposes of explanation. In reality the production tolerances of the various elements of the overall system provide that the leg frame carriage (258) may under normal elastic deformation conditions produce fractional amount of side load when fully loaded. The use of an anti-twist beam (280) eliminates any potential side load by allowing the leg carriage frame (258) to rotate about the anti-twist beam (280) axis rather than attempt to twist the entire scissor lift mechanism. Even though the resulting rotation may only be a fraction of a degree the anti-twist beam (280) allows the scissor lift mechanism to remain vertically aligned and in an optimum operating configuration. The anti-twist beam (280) is fitted directly to the scissor arm hinge bracket (255) and scissor wheel bracket (256) at the bottom of the scissor lift (see FIG. 26). It comprises a hollow section frame and a main shaft mounted on two suitably rated flange bearings. The main shaft is directly connected to the leg carriage frame (258) and can rotate in the flange bearings.

As shown in FIG. 32 the bed is only lifted from the leg end and the full mattress support structure is supported by a pair of cantilevered beams. In this embodiment there is no lifting mechanism at the head end of the bed, which would enable the system to be utilised in intensive care and other specialist care units where crash and resuscitation teams need to access the patient on the bed from behind the head. FIG. 32(a) is the bed flat in its lowest position, approximately 500 mm top of mattress. FIG. 32(b) is the head section raised to its highest position via an internal mechanism situated at the hinge point between the leg and head frame to give an approximate incline of 48 degrees, and FIG. 32(c) is the leg frame raised to the highest position, approximately 900 mm top of mattress and the resulting adjustment to the incline angle of the head frame.

In another embodiment (not shown), the bed frame is larger to incorporate a fixed single bed frame next to the rotating sleep transfer system. As the system only moves in one direction and reverses this embodiment would allow a carer to sleep alongside the user as in a traditional double bed and still maintain the functionality of the original rotating sleep surface transfer system.

FIGS. 33 to 37 illustrate an alternative embodiment of the invention. In FIG. 33 the head and back support (300), seat support (301) and leg support (302) are aligned to provide a continuous horizontal support surface. The drive train comprises longitudinally extending shafts (303,304,305) extending axially of the supports (300,301,302 respectively), with conveyor drive shafts and sprockets as shown in FIG. 9 in relation to the bed drive arrangement. In an alternative embodiment, the drive may comprise two directly driven conveyor shafts as shown in FIG. 8. The shafts are connected by linkages (306, 307) as previously described. A coupling (310) serves to allow connection to a motor drive and control unit as shown in FIG. 7.

A leg frame switch (308) controls a lockable gas spring, a piston (309) to assist in lifting the led frame support once the support has been raised to a predetermined extent. The predetermined extent may be governed by the location of the switch (308), the switch being actuated by contact or proximity with the leg support.

In FIG. 34 the leg support (302) is partially lowered. The coupling (307) is disconnected and the gas spring piston (309) supports the weight of the leg support.

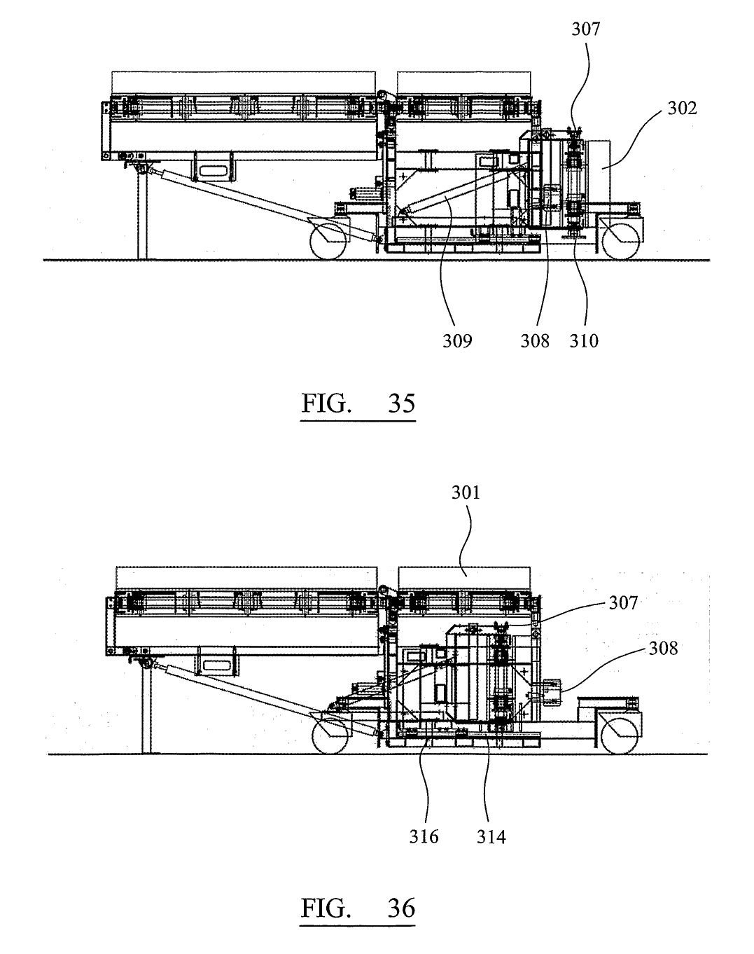

In FIG. 35 the leg support is in the downward position but not retracted.

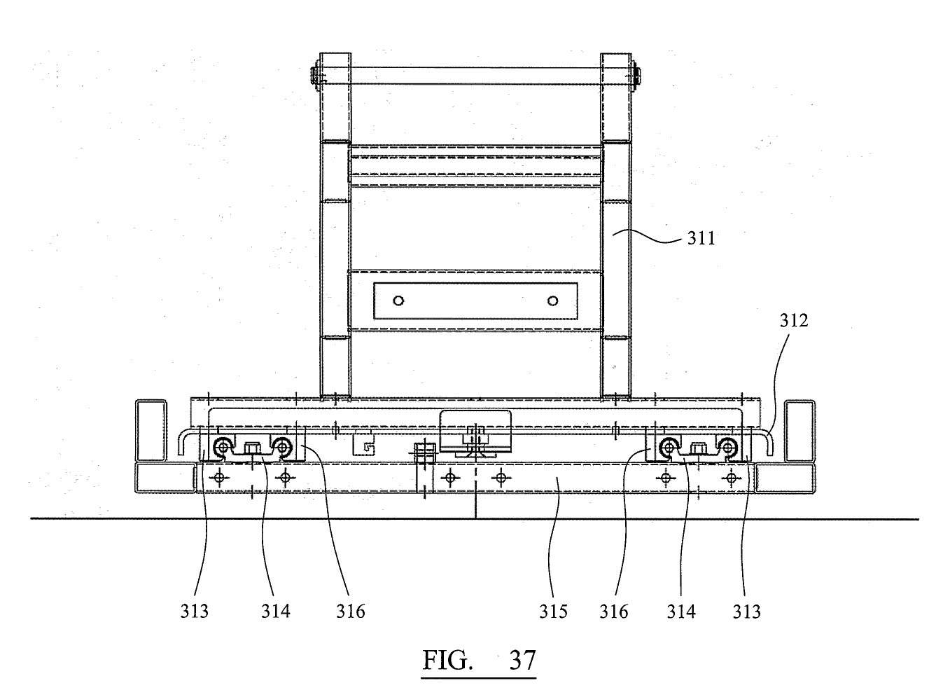

In FIGS. 36 and 37 the leg support is retracted beneath the seat. FIG. 37 shows the carriage (311) and base plate (312) mounted on four bearing blocks (313) on precision linear rails (314) mounted on the transfer table base frame (315). Linear bearing blocks (316) serve to ensure smooth movement of the leg support.

An important advantage is that the length of the seat support (301) can be varied so that the front to back depth of the seat can be selected to suit a user without need for alteration of the dimensions of the leg support and mounting.

FIG. 36 shows the leg rest in the retracted position. The length of the rails (314) is selected to allow the leg support to be completely located beneath the seat irrespective of the size of the seat. In this way a seat may be interchanged with a seat having a greater or lesser depth to suit an occupant's size without any need to adjust the dimensions of the structural components of the assembly.

1. An occupant transfer system comprising a transfer table including a mattress or other sleep support structure mounted on an endless belt of flexible material, the belt extending in a loop over a plurality of rotatable drive members extending longitudinally of the table;
drive means adapted to cause rotation of the belt so that the sleep support structure moves laterally across the table and so that an occupant located on the sleep support structure is moved laterally across the table in use;
a leg support, a seat support and a back or head support arranged to be moveable from a first orientation wherein the supports form a horizontal surface and a second orientation wherein the supports form a chair in which the seat is generally horizontal, the back or head support extends upwardly and the leg support extends downwardly;
the leg support being moveable between a deployed position in which it may be moved to the first orientation and a stowed position in which the leg position is located beneath the seat so that the leg support does not contact a user's legs in use.

2. An occupant transfer system as claimed in claim 1, wherein the leg support is mounted on a carriage moveable between the deployed position to the stowed position.

3. An occupant transfer system as claimed in claim 2, wherein the carriage comprises rollers or sliding members mounted on a track extending beneath the seat.

4. An occupant transfer system as claimed in claim 1, wherein the occupant transfer system further comprises a foot rest to support the soles of an occupant's feet after the leg support has been moved to the stowed position.

5. An occupant transfer system as claimed in claim 1 wherein the bed includes two main drive shafts extending longitudinally of each of leg support, seat support and back or head support portions of the table, the shafts being connectable in use by detachable couplings between the portions, rotatable means on either side of the head and foot portions being operably connected to a respective main shaft so that rotation of the main shafts causes rotation of the rotatable means movement of the conveyor.

6. An occupant transfer system as claimed in claim 1, wherein the rotatable members comprise a drive shaft having one or more rollers or sprockets mounted thereon.

7. An occupant transfer system as claimed in in claim 6 wherein the main drive shaft is connected to the rotatable members by a pulley and belt or sprocket and chain arrangement.

8. An occupant transfer system as claimed in claim 1, wherein the drive mechanism of the transfer table comprises rotatable members on either side of each of the leg, seat and back or head portions, detachable couplings being arranged to connect the shafts to form a continuous drive train on either side of the table when the table is in the horizontal location.

9. An occupant transfer system as claimed in claim 8, wherein the coupling comprises male and female portions mounted on respective shafts, at least one of the male and female portions being outwardly biased by spring means, the male and female portions being disengageable when the shafts are separated but being reengageable when the shafts are brought together, the male portion including a projection receivable within a socket in the female portion to engage the shafts while one of the shafts is rotated in either the clockwise or anticlockwise direction.

10. An occupant transfer system as claimed in claim 9 wherein the male portion comprises an engagement disc mounted transversely on the shaft and having two diametrically opposed projections extending from the disc parallel to the axis of rotation of the shaft; the female portion including an engagement disc mounted transversely on a shaft and having two diametrically opposed sockets dimensioned to receive the projections of the male member.

11. An occupant transfer system as claimed in claim 9, wherein the projections comprise cylindrical pins.

12. An occupant transfer system as claimed in claim 3, wherein the track has a length relocated to permit the leg support to be completely stowed beneath a range of seat sizes to accommodate differently sized occupants.

13. An occupant transfer system as claimed in claim 1, the occupant transfer system further comprising a mobile transfer table drive unit which may be releasably coupled in use to the transfer table drive train.
